(19) United States
(12) Patent Application Publication
(10) Pub. No.: US 2009/0004533 A1
(43) Pub. Date: Jan. 1, 2009

(54) Fuel cell stack

(75) Inventors: Yukihito Tanaka, Utsunomiya-shi (JP); Harumi Hatano, Utsunomiya-shi (JP)

Correspondence Address: LAHIVE & COCKFIELD, LLP;FLOOR 30, SUITE 3000, ONE POST OFFICE SQUARE, BOSTON, MA, 02109, US

(73) Assignee: Honda Motor Co., Ltd., Tokyo (JP)

(21) Appl. No.: 11/900,028

(22) Filed: Sep. 7, 2007

(30) Foreign Application Priority Data
Sep. 8, 2006 (JP) 2006-244121
Oct. 18, 2006 (JP) 2006-284150

(51) Int. Cl. H01M 2/00

(52) U.S. Cl. 429/34

(57) ABSTRACT

In a tightening load applying mechanism, a plurality of belleville springs for applying a load in a stacking direction to a stack body, a plurality of guide bars extending in the stacking direction, and a plurality of bearing members are provided between a movable presser plate and an end plate. The guide bars are slidably inserted into the bearing members in the stacking direction. Each of the bearing members has a housing fixed to the end plate, and a bearing attached to the housing. The guide bar is slidably fitted to the bearing in the stacking direction.

### BACKGROUND OF THE INVENTION

1. Field of the Invention

The present invention relates to a fuel cell stack including a stack body, end plates, and a movable presser plate provided between one of the end plates and the stack body. The stack body is formed by stacking electrolyte electrode assemblies and separators. Each of the electrolyte electrode assemblies includes a pair of electrodes and an electrolyte interposed between the electrodes.

2. Description of the Related Art

For example, a polymer electrolyte fuel cell employs a membrane electrode assembly (electrolyte electrode assembly) which includes an anode, a cathode, and an electrolyte membrane interposed between the anode and the cathode. The electrolyte membrane is a solid polymer ion exchange membrane. The membrane electrode assembly and separators sandwiching the membrane electrode assembly make up a unit of a power generation cell (unit cell) for generating electricity. In use, normally, a predetermined number of power generation cells are stacked together to form a fuel cell stack together with end plates disposed at both ends in the stacking direction.

In the fuel cell stack, it is necessary to apply a desired surface pressure to electrical reaction areas of power generation cells, and a desired surface pressure to sealing areas for reactant gases and a coolant. For example, in a fuel cell stack disclosed in Japanese Laid-Open Patent Publication No. 2004-335336, as shown in FIG. 16, a stack body 3 formed by stacking unit cells 1 and separators 2 is placed in a cylinder 4.

A non-movable end plate 5 contacts one end of the stack body 3, and a movable end plate 6 contacts the other end of the stack body 3. The movable end plate 6 is divided into an inner part 6a corresponding to the electrical reaction areas of the unit cells 1, and an outer part 6b corresponding to the sealing areas. The inner part 6a and the outer part 6b are pressed to the stack body 3 by an inner spring 7a and an outer spring 7b, respectively.

In the above conventional technique, the movable end plate 6 is placed in the cylinder 4. In the structure, the movable end plate 6 does not slide smoothly in the cylinder 4 in the stacking direction. In particular, in the case where the stack body 3 has a rectangular shape in a plan view, it is extremely difficult to keep tolerances of the outer circumference of the movable end plate 6 and the inner circumference of the cylinder 4 within predetermined ranges of accuracy to achieve smooth sliding of the movable end plate 6.

### SUMMARY OF THE INVENTION

A main object of the present invention is to provide a fuel cell stack in which it is possible to suitably absorb change in a tightening load due to contraction or the like of a stack body, and a desired surface pressure is reliably applied to the stack body.

The present invention relates to a fuel cell stack comprising a stack body, end plates sandwiching the stack body, and a movable presser plate interposed between one of the end plates and the stack body. The stack body is formed by stacking electrolyte electrode assemblies and separators in a stacking direction. Each of the electrolyte electrode assemblies includes a pair of electrodes and an electrolyte interposed between the electrodes.

The fuel cell stack further comprises an elastic member provided between the movable presser plate and the one end plate for applying a load in the stacking direction to the stack body, a plurality of guide bars extending in the stacking direction, and a plurality of bearing members. The guide bars are slidably inserted into the bearing members in the stacking direction.

Further, according to another aspect of the present invention, the fuel cell stack comprises an elastic member provided between the movable presser plate and the one end plate for applying a load in the stacking direction to the stack body, and a guide mechanism for moving the movable presser plate in the stacking direction, while keeping the movable presser plate in parallel with the one end plate. The guide mechanism at least includes two or more pipes extending in the stacking direction, and connected to a reactant gas flow field or a coolant flow field provided in the stack body.

In the present invention, by the guidance of the guide bars and bearing members extending in the stacking direction, the movable presser plate can smoothly and reliably slide in the stacking direction. Thus, it is possible to absorb the change in a tightening load due to contraction of the stack body or the like. For example, it becomes possible to reliably apply suitable surface pressures to the electrical reaction areas and sealing areas.

Further, in the present invention, by the guidance of two or more pipes extending in the stacking direction, the movable presser plate is kept in parallel with one of the end plates, and smoothly and reliably slides in the stacking direction. Thus, in the simple structure, for example, it becomes possible to absorb the change in a tightening load due to contraction of the stack body or the like, while, for example, reliably applying suitable surface pressures to the electrical reaction areas and sealing areas.

The above and other objects, features and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is an exploded perspective view showing a fuel cell stack according to a first embodiment of the present invention;

FIG. 2 is a side view, partially in cross section, showing the fuel cell stack;

FIG. 3 is an exploded perspective view showing a unit cell of the fuel cell stack;

FIG. 4 is an exploded perspective view showing a tightening load applying mechanism of the fuel cell stack;

FIG. 5 is a view showing a tightening load applying mechanism incorporating another bearing member;

FIG. 6 is a side view, partially in cross section, showing a fuel cell stack according to a second embodiment of the present invention;

FIG. 7 is an exploded perspective view showing a tightening load applying mechanism of the fuel cell stack;

FIG. 8 is a view schematically showing a state in which a fuel cell stack according to a third embodiment is mounted on a vehicle body of an automobile;

FIG. 9 is a plan view showing the vehicle body;

FIG. 10 is an exploded perspective view showing the fuel cell stack;

FIG. 11 is a side view, partially in cross section, showing the fuel cell stack;

FIG. 12 is an exploded perspective view showing a tightening load applying mechanism of the fuel cell stack;

FIG. 13 is a side view, partially in cross section, showing a fuel cell stack according to a fourth embodiment of the present invention;

FIG. 14 is an exploded perspective view showing a fuel cell stack according to a fifth embodiment of the present invention;

FIG. 15 is a side view, partially in cross section, showing the fuel cell stack; and

FIG. 16 is a cross sectional view showing a conventional fuel cell stack.

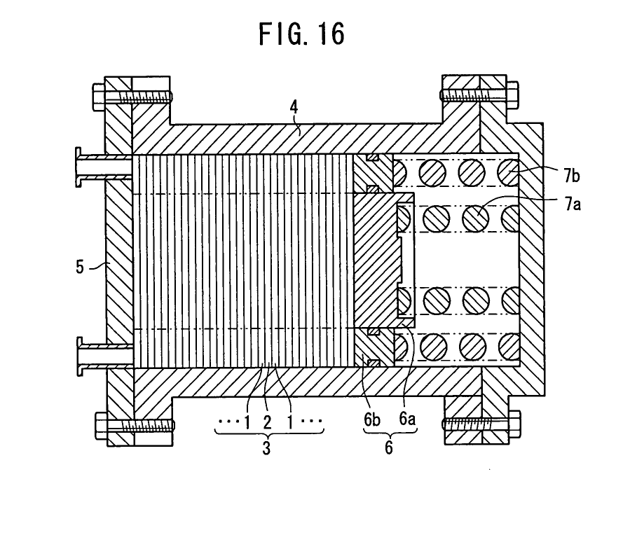

### DESCRIPTION OF THE PREFERRED EMBODIMENTS

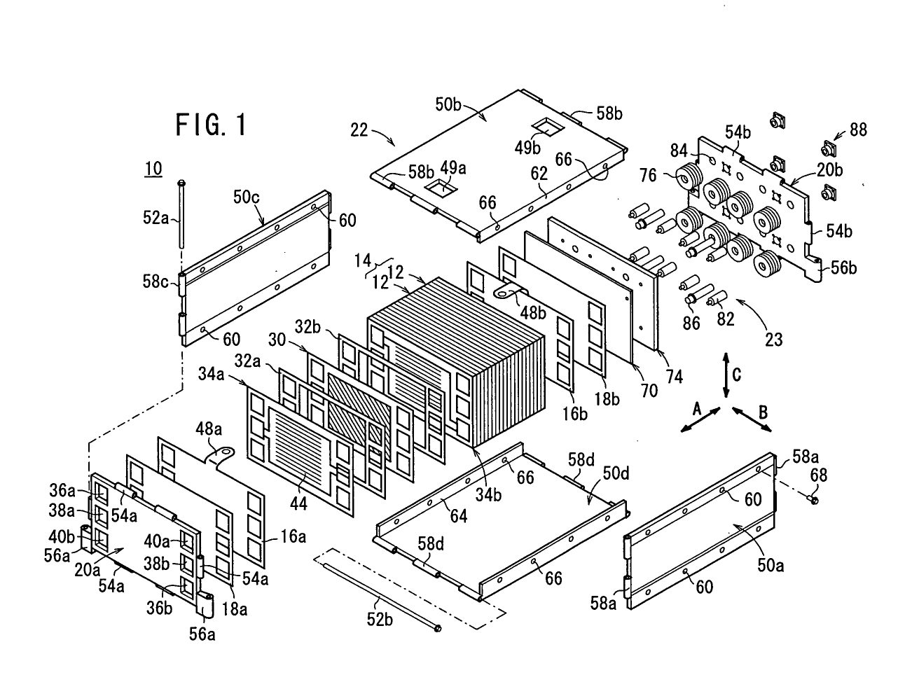

FIG. 1 is an exploded perspective view showing a fuel cell stack 10 according to a first embodiment of the present invention.

The fuel cell stack 10 includes a stack body 14 formed by stacking a plurality of unit cells 12 in a direction indicated by an arrow A. The unit cells 12 are electrically connecting in series. At opposite ends of the stack body 14 in a stacking direction, terminal plates 16a, 16b are provided. Insulating plates 18a, 18b are provided outside the terminal plates 16a, 16b. Further, end plates 20a, 20b are provided outside the insulating plates 18a, 18b. The stack body 14 is provided in a casing 22. As described later, a support plate 70 and a tightening load applying mechanism 23 are provided between the insulating plate 18b and the end plate 20b. Further, instead of using the casing 22, components between the end plates 20a, 20b may be fixed by a plurality of bolts.

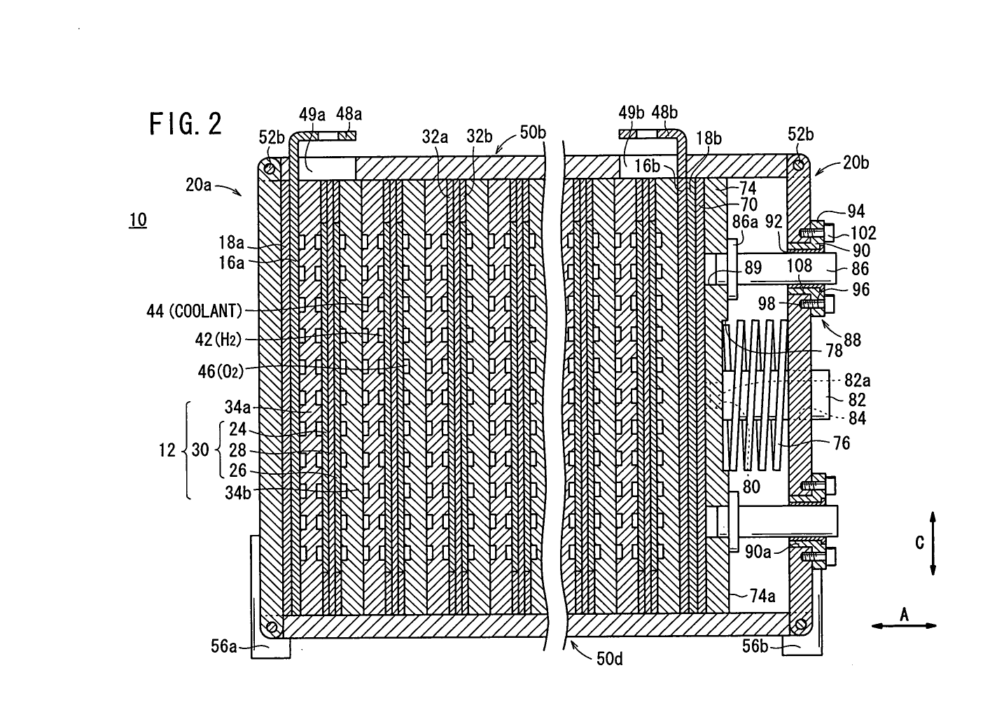

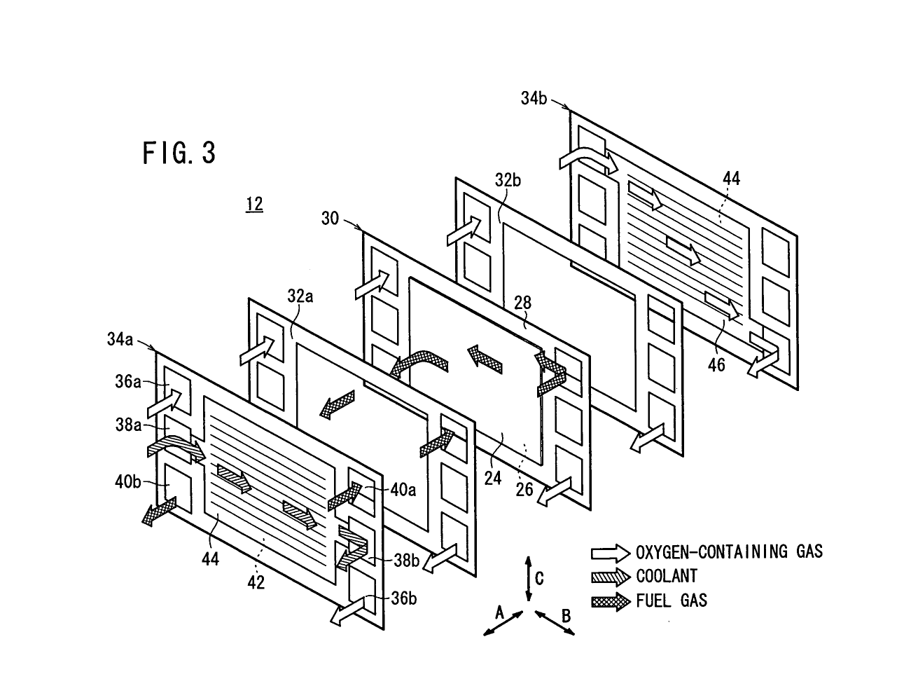

As shown in FIGS. 2 and 3, each of the unit cells 12 includes a membrane electrode assembly (electrolyte electrode assembly) 30. The membrane electrode assembly 30 includes an anode 24, a cathode 26, and a solid polymer electrolyte membrane 28 interposed between the anode 24 and the cathode 26. As the solid polymer electrolyte membrane 28, for example, a hydrogen ion conductor formed by impregnating a thin membrane of polytetrafluoroethylene sulfonic acid with water is adopted.

Each of the anode 24 and the cathode 26 has a gas diffusion layer such as a carbon paper, and an electrode catalyst layer of platinum alloy supported on porous carbon particles. The carbon particles are deposited uniformly on the surface of the gas diffusion layer. The electrode catalyst layer of the anode 24 and the electrode catalyst layer of the cathode 26 are fixed to both surfaces of the solid polymer electrolyte membrane 28, respectively.

The membrane electrode assembly 30 is sandwiched between the separators 34a, 34b such that gaskets 32a, 32b are interposed between the membrane electrode assembly 30 and the separators 34a, 34b. The separators 34a, 34b are metal plates or carbon plates.

At one end of the unit cell 12 in a longitudinal direction indicated by an arrow B in FIG. 3, an oxygen-containing gas supply passage 36a for supplying an oxygen-containing gas, a coolant supply passage 38a for supplying a coolant, and a fuel gas discharge passage 40b for discharging a fuel gas such as a hydrogen-containing gas are arranged in a direction indicated by an arrow C. The oxygen-containing gas supply passage 36a, the coolant supply passage 38a, and the fuel gas discharge passage 40b extend through the unit cell 12 in a direction indicated by an arrow A.

At the other end of the unit cell 12 in the longitudinal direction, a fuel gas supply passage 40a for supplying the fuel gas, a coolant discharge passage 38b for discharging the coolant, and an oxygen-containing gas discharge passage 36b are arranged in a direction indicated by an arrow C. The fuel gas supply passage 40a, the coolant discharge passage 38b, and the oxygen-containing gas discharge passage 36b extend through the unit cell 12 in the direction indicated by the arrow A.

The separator 34a has a fuel gas flow field 42 on a surface facing the membrane electrode assembly 30. The fuel gas flow field 42 is connected to the fuel gas supply passage 40a and the fuel gas discharge passage 40b. For example, the fuel gas flow field 42 comprises a plurality of grooves extending in a direction indicated by an arrow B. The separator 34a has a coolant flow field 44 on the surface opposite to the membrane electrode assembly 30. The coolant flow field 44 is connected to the coolant supply passage 38a and the coolant discharge passage 38b. For example, the coolant flow field 44 comprises a plurality of grooves extending in the direction indicated by the arrow B.

The separator 34b has an oxygen-containing gas flow field 46 on a surface facing the membrane electrode assembly 30. For example, the oxygen-containing gas flow field 46 comprises a plurality of grooves extending in a direction indicated by an arrow B. The oxygen-containing gas flow field 46 is connected to the oxygen-containing gas supply passage 36a and the oxygen-containing gas discharge passage 36b. The separator 34b has the coolant flow field 44 on a surface opposite to the membrane electrode assembly 30. When the separators 34a, 34b are stacked together, the coolant flow field 44 is formed between the surfaces of the separators 34a, 34b.

As shown in FIG. 1, plate like terminals 48a, 48b are formed at ends of the terminal plates 16a, 16b. The plate like terminals 48a, 48b protrude along a surface of the stack body 14. The terminals 48a, 48b pass through openings 49a, 49b formed in a side plate 50b as described later. For example, a load such as a motor for traveling is connected to the terminals 48a, 48b.

The casing 22 includes the end plates 20a, 20b, a plurality of side plates 50a to 50d provided on sides of the stack body 14, and coupling pins 52a, 52b having different lengths for coupling the end plates 20a, 20b to the side plates 50a to 50d.

A predetermined number of bosses 54a, 54b protrude from respective upper and lower, and left and right sides of the end plates 20a, 20b. Mounting bosses 56a, 56b protrude from lower positions of each of the left and right sides. A predetermined number of bosses 58a to 58d protrude from opposite ends of the side plates 50a to 50d in a longitudinal direction.

At upper and lower ends of the side plates 50a, 50c, a plurality of holes 60 are formed. At opposite ends of the side plates 50b, 50d in a lateral direction, folded portions 62, 64 are formed. The folded portions 62, 64 have screw holes 66 at positions corresponding to the holes 60. By inserting bolts 68 to the holes 60, and screwing the bolts 60 into the screw holes 66, the side plates 50a to 50d are assembled.

The coupling pins 52a are inserted into bosses 58a, 58c of the side plates 50a, 50c and the left and right bosses 54a, 54b of the end plates 20a, 20b, and the coupling pins 52b are inserted into the bosses 58b, 58d of the side plates 50b, 50d and upper and lower bosses 54a, 54b of the end plates 20a, 20b to form the casing 22.

The end plate 20b is stacked on the insulating plate 18b such that the support plate 70 and the tightening load applying mechanism 23 are interposed between the end plate 20b and the insulating plate 18b. The support plate 70 functions to seal the oxygen-containing gas supply passage 36a, the oxygen-containing gas discharge passage 36b, the fuel gas supply passage 40a, the fuel gas discharge passage 40b, the coolant supply passage 38a, and the coolant discharge passage 38b.

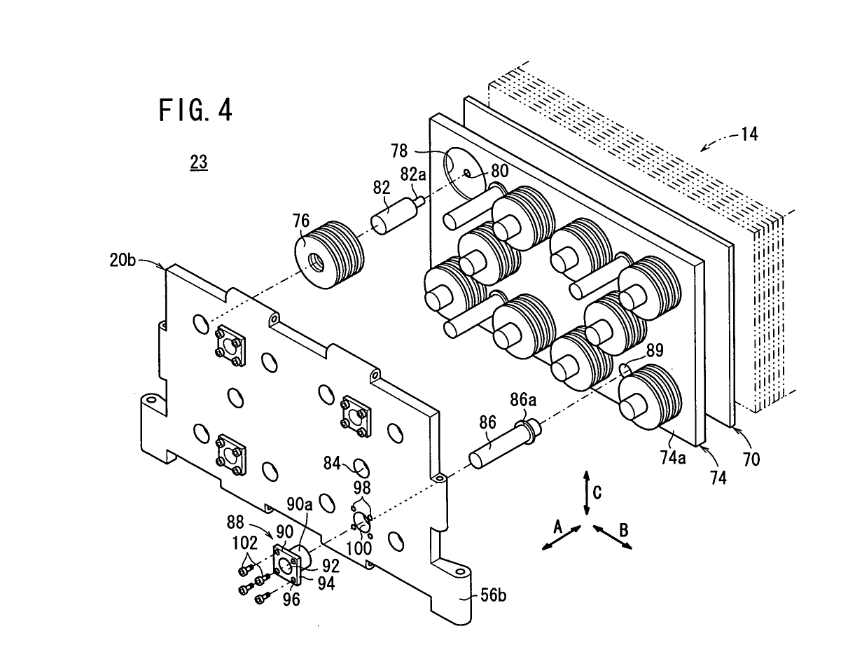

As shown in FIG. 4, the tightening load applying mechanism 23 includes a movable presser plate 74 stacked on the support plate 70. Disk shaped recesses 78 are formed on a surface 74a of the movable presser plate 74 facing the end plate 20b. A predetermined number of elastic members, e.g., ten pairs of belleville springs (or coil springs, rubber members, resin members) 76 are disposed in each of the disc shaped recesses 78. A hole 80 is formed at the center of each recess 78. A small diameter front end 82a of a support shaft 82 is inserted into the hole 80 under pressure, and the belleville springs 76 are supported by the support shaft 82. The end plate 20b have holes 84 for inserting the support shafts 82.

A plurality of guide bars 86 extending in the stacking direction indicated by the arrow A are provided at the movable presser plate 74. The end plate 20b has a plurality of bearing members 88. The guide bars 86 are slidably inserted into the bearing members 88. The guide bar 86 has a substantial rod shape, and a flange 86a is formed near one end of the guide bar 86. The movable presser plate 74 has holes 89. A predetermined number of, e.g., four guide bars 86 are inserted from one end of the flange 86a into the holes 89.

As shown in FIGS. 2 and 4, the bearing member 88 includes a housing 90 and a bearing 92 provided in the housing 90. Four holes 96 are provided in a flange portion 94 of the housing 90, and the end plate 20b has bolt holes 98 corresponding to the holes 96. A hole 100 is formed at the center of the four bolt holes 98.

Bolts 102 are inserted into the holes 96 of the hosing 90. Tip ends of the bolts 102 are inserted into the bolt holes 98 to fix the housing 90 to the end plate 20b. The diameter of the hole 96 is larger than the diameter of the bolt 102. Thus, the bolt 102 can be reliably screwed into the bolt hole 98. A shaft portion 90a of the housing 90 is screwed into the hole 100, and the bearing 92 is provided in the shaft portion 90a. The guide bar 86 is slidably fitted to the bearing 92 in the stacking direction.

Operation of the fuel cell stack 10 will be described.

Firstly, as shown in FIG. 1, in the fuel cell stack 10, an oxygen-containing gas is supplied to the oxygen-containing gas supply passage 36a of the end plate 20a, and a fuel gas such as a hydrogen-containing gas is supplied to the fuel gas supply passage 40a of the end plate 20a. Further, the coolant such as pure water or ethylene glycol or oil is supplied to the coolant supply passage 38a of the end plate 20a. Thus, in the stack body 14, the oxygen-containing gas, the fuel gas, and the coolant are supplied to the unit cells 12 stacked in the direction indicated by the arrow A.

As shown in FIG. 3, the oxygen-containing gas from the oxygen-containing gas supply passage 36a flows into the oxygen-containing gas flow field 46 of the separator 34b, and flows along the cathode 26 of the membrane electrode assembly 30. Likewise, the fuel gas from the fuel gas supply passage 40a flows into the fuel gas flow field 42 of the separator 34a, and flows along the anode 24 of the membrane electrode assembly 30.

Thus, in each of the membrane electrode assemblies 30, the oxygen-containing gas supplied to the cathode 26, and the fuel gas supplied to the anode 24 are consumed in the electrochemical reactions at catalyst layers of the cathode 26 and the anode 24 for generating electricity.

Then, the oxygen-containing gas consumed at the cathode 26 flows along the oxygen-containing gas discharge passage 36b, and thereafter, the oxygen-containing gas is discharged to the outside from the end plate 20a. Likewise, the fuel gas consumed at the anode 24 is discharged into the fuel gas discharge passage 40b, and thereafter, the fuel gas is discharged to the outside from the end plate 20a.

Further, the coolant flows into the coolant flow field 44 between the separators 34a, 34b from the coolant supply passage 38a, and flows in the direction indicated by the arrow B. After the coolant is used for cooling the membrane electrode assembly 30, the coolant flows through the coolant discharge passage 38b, and is discharged from the end plate 20a.

In the first embodiment, the load in the stacking direction is applied to the movable presser plate 74 by the belleville springs 76. The guide bars 86 extending in the stacking direction are fixed to the movable presser plate 74. The end plate 20b has the bearing members 88, and the guide bars 86 are slidably inserted into the bearing members 88 in the stacking direction.

In the structure, as shown in FIG. 2, by the guidance of the guide bars 86 extending in the stacking direction and the bearing members 88, the movable presser plate 74 smoothly and reliably slides in the stacking direction. Thus, by the sliding movement of the movable presser plate 74, the change in the tightening load due to contraction or the like of the stack body 14 can be absorbed reliably, and it becomes possible to apply the desired surface pressures uniformly to the electrical reaction areas and the sealing areas of the respective unit cells 12.

Further, in the first embodiment, the separate belleville springs 76 and the separate guide bars 86 are arranged in parallel. Therefore, the dimensions of the belleville springs 76 can be designed freely, and the shape of the bearing members 88 can be designed freely.

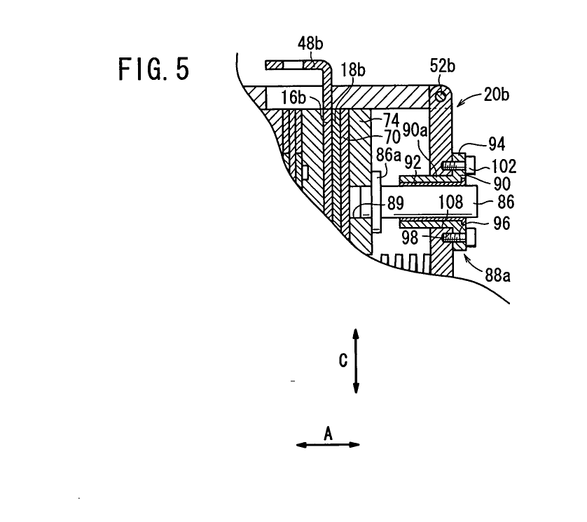

Specifically, in a bearing member 88a shown in FIG. 5, the thickness of a shaft portion 90a is larger than the thickness of the end plate 20b. Thus, the movable presser plate 74 can slide further smoothly in the stacking direction.

Further, in the fuel cell stack 10, the manifolds for the fuel gas, the oxygen-containing gas, and the coolant are locally provided on the end plate 20a side, and no manifolds of these types are provided on the end plate 20b side. Only the tightening load applying mechanism 23 is provided on the end plate 20b side. Thus, at the end plate 20a, fixed pipes may be provided as the respective manifolds. Therefore, the layout of the pipes is simplified easily.

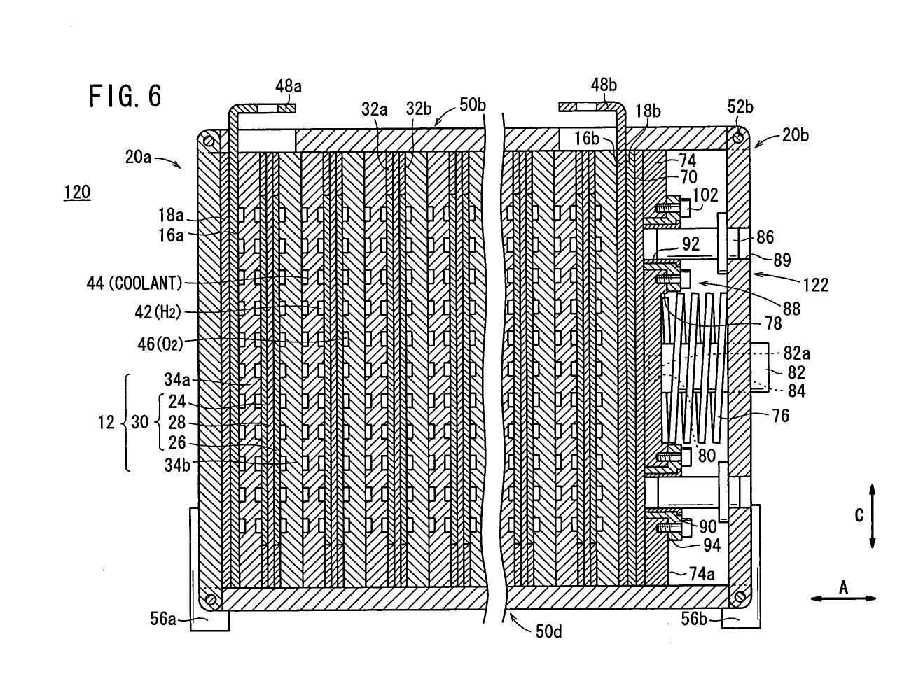

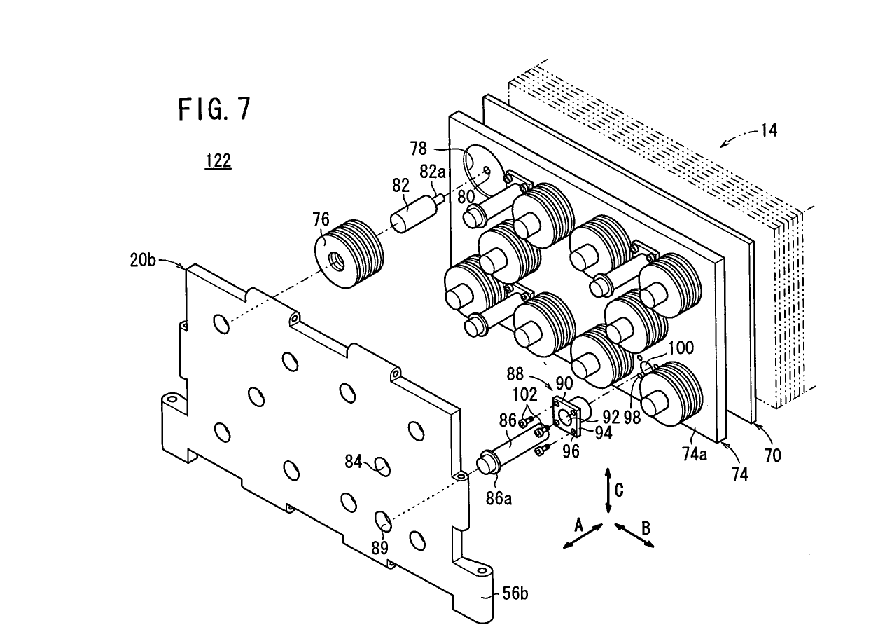

FIG. 6 is a cross sectional view, partially in cross section, showing a fuel cell stack 120 according to a second embodiment of the present invention. FIG. 7 is an exploded perspective view showing a tightening load applying mechanism 122 of the fuel cell stack 120.

The constituent elements that are identical to those of the fuel cell stack 10 according to the first embodiment are labeled with the same reference numeral, and description thereof will be omitted. Further, also in the third to fifth embodiments as descried later, the constituent elements that are identical to those of the fuel cell stack 10 according to the first embodiment are labeled with the same reference numeral, and description thereof will be omitted.

The tightening load applying mechanism 122 includes a plurality of guide bars 86 fixed to the end plate 20b, and bearing members 88 attached to the movable presser plate 74. The end plate 20b has holes 89, and the guide bars 86 are inserted into the holes 89 under pressure. The movable presser plate 74 is relatively thick, and the housing 90 of each of the bearing members 88 is fixed to the movable presser plate 74 using the bolts 102.

In the second embodiment, by the guidance of the bearing members 88 attached to the movable presser plate 74 and the guide bars 86 extending in the stacking direction, and fixed to the end plate 20b, the movable presser plate 74 smoothly and reliably slides in the stacking direction. Thus, the same advantages as in the case of the first embodiment can be obtained. For example, it becomes possible to apply the desired surface pressure uniformly to the stack body 14.

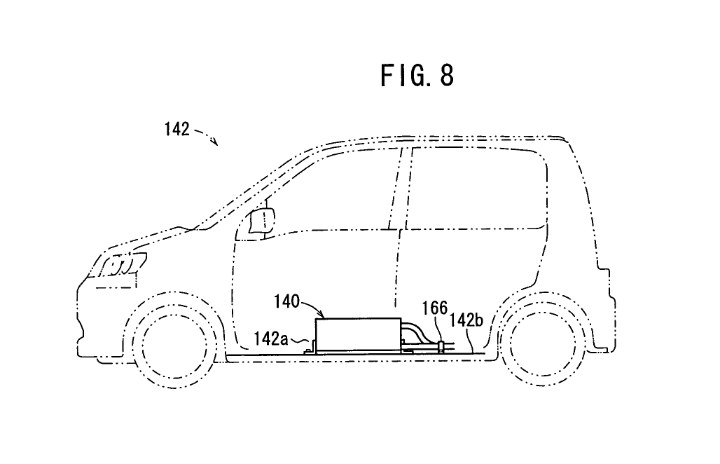

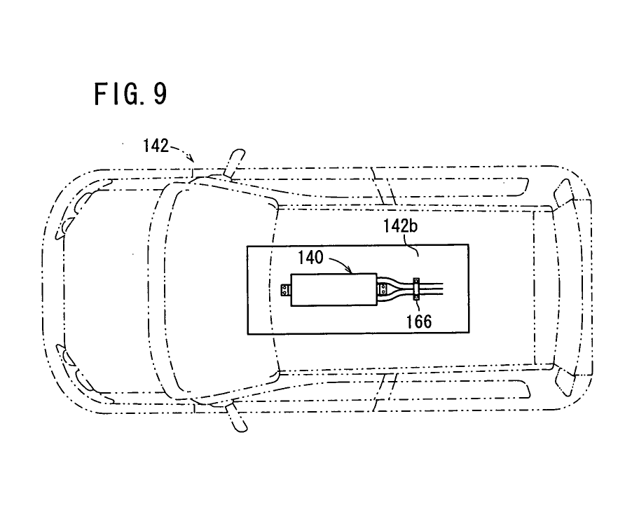

FIG. 8 is a view schematically showing a state in which a fuel cell stack 140 according to a third embodiment is mounted in a vehicle body 142 of an automobile. FIG. 9 is a plan view showing the vehicle body 142. Preferably, the fuel cell stack 140 is mounted at substantially the center of an area 142a under the floor of the vehicle body 142.

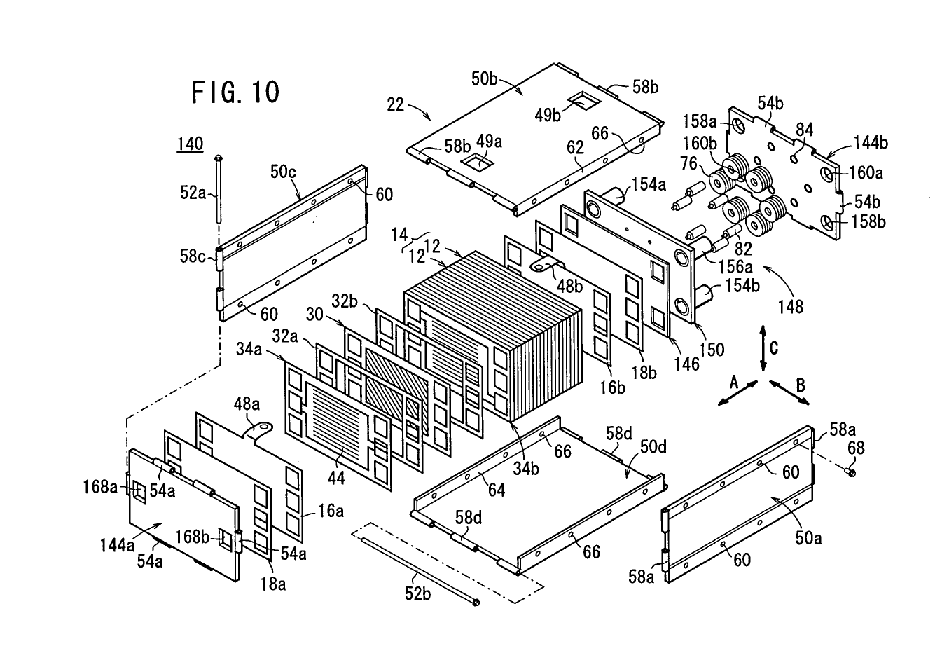

As shown in FIG. 10, the fuel cell stack 140 includes a stack body 14 formed by stacking a plurality of unit cells 12 in a direction indicated by an arrow A. The unit cells 12 are electrically connected together in series. At opposite ends of the stack body 14 in the stacking direction, terminal plates 16a, 16b are provided. Insulating plates 18a, 18b are provided outside the terminal plates 16a, 16b. Further, end plates 144a, 144b are provided outside the insulating plates 18a, 18b. The stack body 14 is placed in a casing 22.

The insulating plate 18b is stacked on the end plate 144b such that a support plate 146 and a tightening load applying mechanism 148 are interposed between the insulating plate 18b and the end plate 144b. For example, the support plate 146 functions to seal the coolant supply passage 38a and the coolant discharge passage 38b.

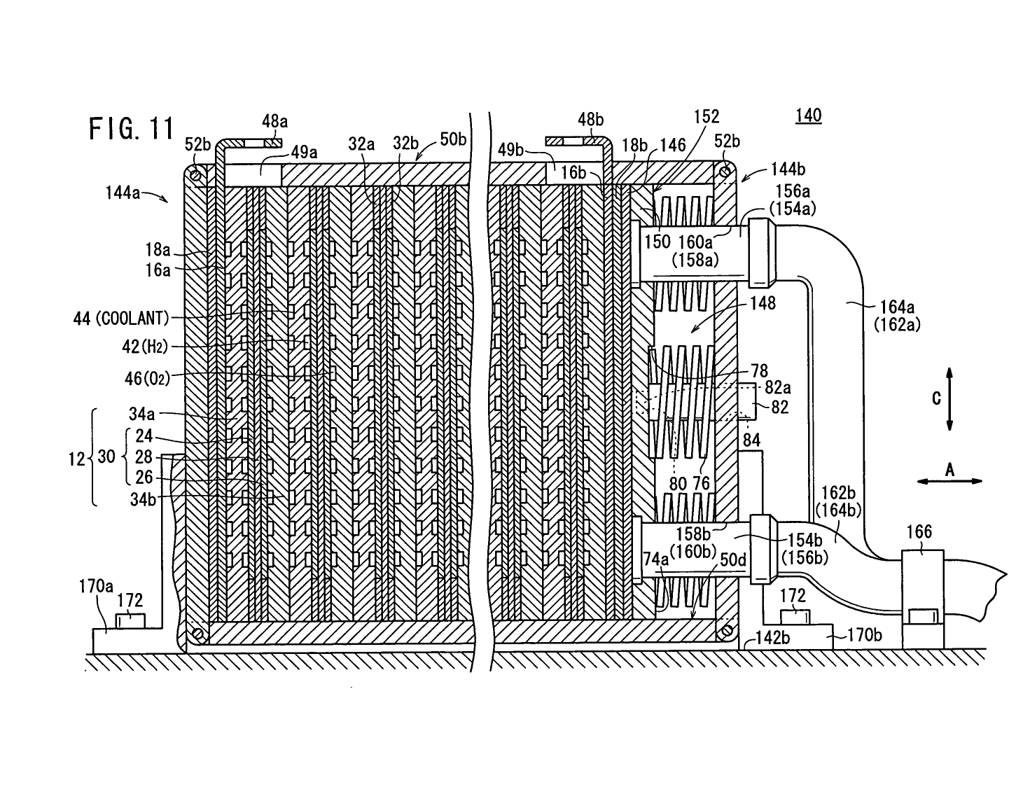

As shown in FIGS. 10 and 11, the tightening load applying mechanism 148 includes the movable presser plate 150 stacked on the support plate 146, and the tightening load applying mechanism 148 includes a guide mechanism 152. The guide mechanism 152 moves the movable pressure plate 150 in the stacking direction indicated by the arrow A, while keeping the movable pressure plate 150 in parallel with the end plate 144b. The guide mechanism 152 has two or more, e.g., four pipes 154a, 154b, 156a, 156b extending in the stacking direction. The pipes 154a, 154b, 156a, 156b are connected to, e.g., the fuel gas flow field 42 and the oxygen-containing gas flow field 46, among the fuel gas flow field 42, the oxygen-containing gas flow field 46, and the coolant flow field 44.

The pipes 154a, 154b are connected to the oxygen-containing gas supply passage 36a and the oxygen-containing gas discharge passage 36b, and the pipes 156a, 156b are connected to the fuel gas supply passage 40a and the fuel gas discharge passage 40b. The pipes 154a, 154b, 156a, 156b are made of relatively hard resin material or metal material, and fixed to the movable presser plate 150.

Alternatively, the pipes 154a, 154b, 156a, 156b may be fixed to the support plate 146. Further, the guide mechanism 152 may be made up of the two pipes 154a, 154b, or the two pipes 156a, 156b. The guide mechanism 152 also may be made up of pipes (not shown) connected to the coolant supply passage 38a and the coolant discharge passage 38b.

The end plate 144b has holes 158a, 158b, 160a, 160b. The pipes 154a, 154b, 156a, 156b are slidably fitted to the holes 158a, 158b, 160a, 160b, and extend to the outside of the end plate 144b. The tip ends of the pipes 154a, 154b, 156a, 156b are connected to ends of rubber pipes (pipe members) 162a, 162b, 164a, 164b.

The rubber pipes 162a, 162b, 164a, 164b are made of relatively soft material such as ethylene propylene diene terpolymer (EPDM) which is deformable to follow the movement of the movable presser plate 150 in the direction indicated by the arrow A. The rubber pipes 162a, 162b, 164a, 164b are fixed to a vehicle body frame 142b of the vehicle body 142 via a non-movable member 166 (see FIG. 9). Instead of the rubber pipes 162a, 162b, 164a, 164b, bellows type pipes may be used.

As shown in FIG. 10, the end plate 144a has holes 168a, 168b connected to the coolant supply passage 38a and the coolant discharge passage 38b. Coolant manifold pipes (not shown) are provided at the holes 168a, 168b.

As shown in FIG. 11, a mount member 170a is provided at the end plate 144a. The mount member 170a is fixed to the vehicle body frame 142b using bolts 172. Likewise, a mount member 170b is provided at the end plate 144b. The mount member 170b is fixed to the vehicle body frame 142b using bolts 172.

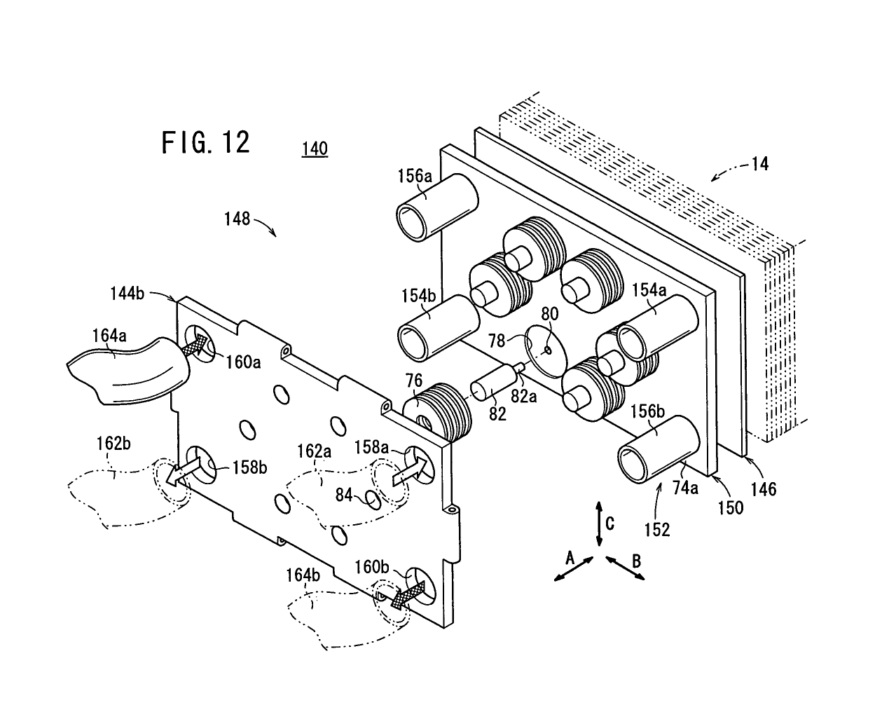

In the fuel cell stack 140, as shown in FIG. 12, on the end plate 144b side, the oxygen-containing gas is supplied from the rubber pipe 162a to the pipe 154a. The fuel gas such as the hydrogen-containing gas is supplied from the rubber pipe 164a to the pipe 156a. The oxygen-containing gas is supplied to the oxygen-containing gas supply passage 36a connected to the pipe 154a, and the fuel gas is supplied to the fuel gas supply passage 40a connected to the pipe 156a.

Further, as shown in FIG. 10, on the end plate 144a side, the coolant such as pure water, ethylene glycol, or oil is supplied from the hole 168a through the coolant manifold (not shown). Thus, in the stack body 14, the oxygen-containing gas, the fuel gas, and the coolant are supplied to the unit cells 12 stacked in the direction indicated by the arrow A, from the opposite sides in the direction indicated by the arrow A.

As shown in FIG. 12, the oxygen-containing gas consumed at the cathode 26 flows along the oxygen-containing gas discharge passage 36b, and then, the oxygen-containing gas is discharged from the pipe 154b to the outside of the end plate 144b through the rubber pipe 162b. Likewise, the fuel gas consumed at the anode 24 flows along the fuel gas discharge passage 40b, and then, the fuel gas is discharged from the pipe 156b to the outside of the end plate 144b through the rubber pipe 164b.

Further, the coolant is supplied from the coolant supply passage 38a to the coolant flow field 44 between the separators 34a, 34b, and then, the coolant flows in the direction indicated the by the arrow B. After the coolant is used for cooling the membrane electrode assembly 30, the coolant flows through the coolant discharge passage 38b, and the coolant is discharged to the outside of the end plate 144a (see FIG. 10).

In the third embodiment, the load in the stacking direction is applied to the movable presser plate 150 by the belleville springs 76, and the movable presser plate 150 has the pipes 154a, 154b, 156a, 156b extending in the stacking direction. The end plate 144b has the holes 158a, 158b, 160a, 160b, and the pipes 154a, 154b, 156a, 156b are slidably inserted into the holes 158a, 158b, 160a, 160b.

Therefore, as shown in FIG. 11, by the guidance of the pipes 154a, 154b, 156a, 156b extending in the stacking direction, the movable presser plate 150 is kept in parallel with the end plate 144b, and slides smoothly and reliably in the stacking direction. Thus, for example, by the sliding operation of the movable presser plate 150, the change in the tightening load due to contraction or the like of the stack body 14 can be absorbed reliably, and it becomes possible to apply the desired surface pressure uniformly to the electrical reaction areas and the sealing areas of the respective unit cells 12.

Further, in the third embodiment, the guide mechanism 152 includes the pipe 154a connected to the oxygen-containing gas supply passage 36a, the pipe 154b connected to the oxygen-containing gas discharge passage 36b, the pipe 156a connected to the fuel gas supply passage 40a, and the pipe 156b connected to the fuel gas discharge passage 40b. Thus, no dedicated structure for moving the movable presser plate 150, while keeping the movable presser plate 150 in parallel with the end plate 144b is required. Thus, structure of the guide mechanism 152 is simplified significantly and economically.

Further, the rubber pipes 162a, 162b, 164a, 164b connected to the pipes 154a, 154b, 156a, 156b are deformed easily to follow the movement of the movable presser plate 150 in the stacking direction, as a buffer between a non-movable member 166 and the end plate 144b.

In the structure, the rubber pipes 162a, 162b, 164a, 164b do not cause deformation or movement in the area opposite to the area from the non-movable member 166 to the end plate 144b. Therefore, undesirable gas leakage or the like does not occur in the fuel gas supply/discharge mechanism (not shown) and the oxygen-containing gas supply/discharge mechanism (not shown) connected to the rubber pipes 162a, 162b, 164a, 164b.

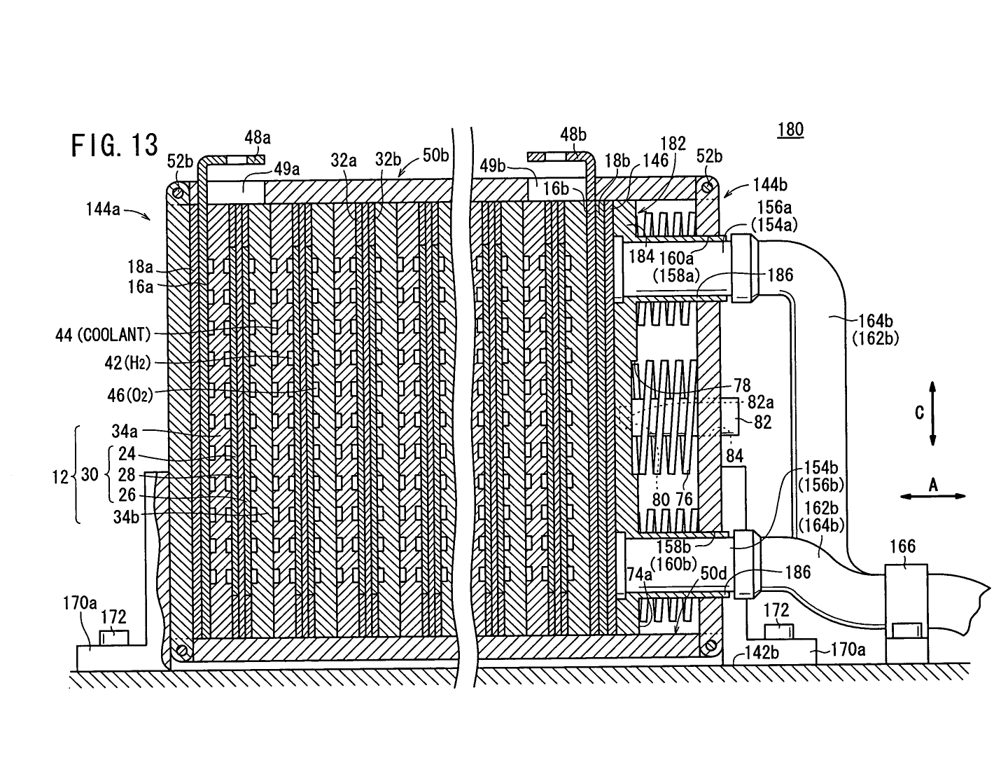

FIG. 13 is a side view, partially in cross section, showing a fuel cell stack 180 according to a fourth embodiment of the present invention.

A guide mechanism 182 of the fuel cell stack 180 has a plurality of cylindrical portions 186 formed integrally with the movable presser plate 184. The pipes 154a, 154b, 156a, 156b are fitted to the cylindrical portions 186, and slidably fitted to holes 158a, 158b, 160a, 160b of the end plate 144b.

In the fourth embodiment, the pipes 154a, 154b, 156a, 156b are inserted into the cylindrical portions 186, and function as guide shafts for moving the movable presser plate 184, while keeping the movable presser plate 184 in parallel with the end plate 144b. Thus, the same advantages as in the case of the third embodiment can be obtained.

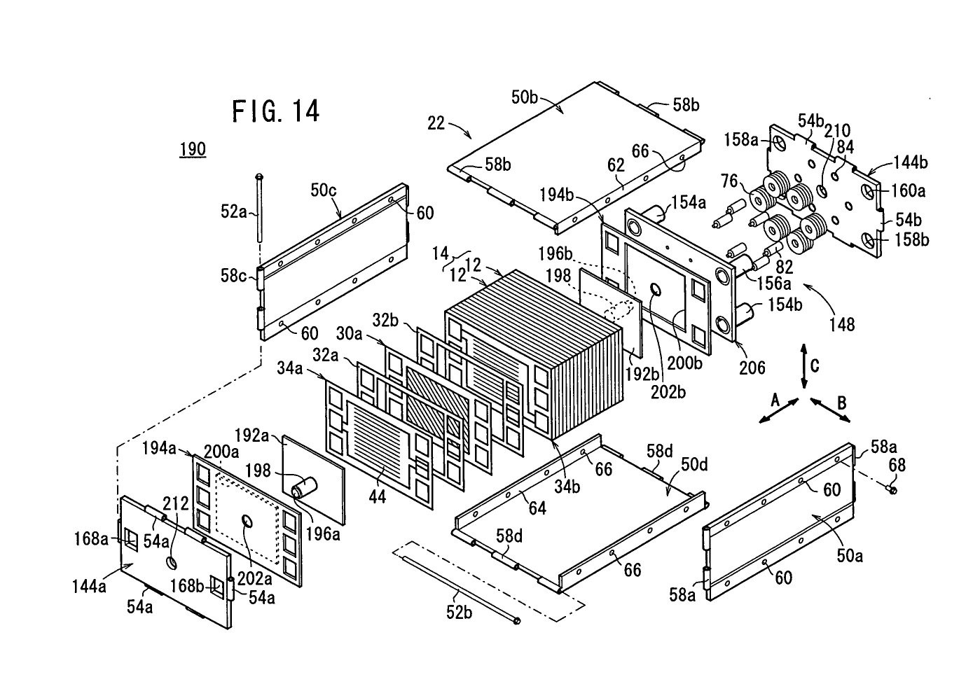

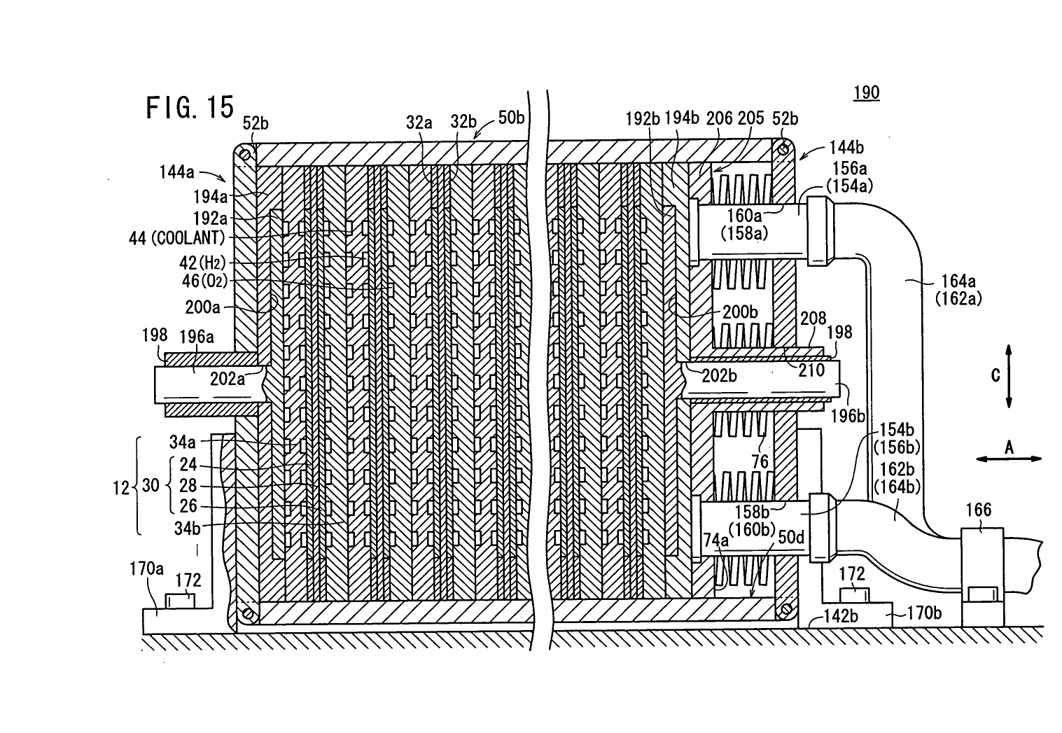

FIG. 14 is an exploded perspective view showing a fuel cell stack 190 according to a fifth embodiment of the present invention. FIG. 15 is a side view, partially in cross section, showing the fuel cell stack 190.

The fuel cell stack 190 includes terminal plates 192a, 192b provided at opposite ends of the stack body in the stacking direction. Insulating plates 194a, 194b are provided outside the terminal plates 192a, 192b. End plates 144a, 144b are provided outside the insulating plates 194a, 194b.

Current collection terminals 196a, 196b are provided at substantially the centers of the terminal plates 192a, 192b. The current collection terminals 196a, 196b extend outwardly in the stacking direction. The terminals 196a, 196b have a substantially columnar shape, and are inserted into respective insulating cylindrical bodies 198 to the outside of the end plates 144a, 144b.

Rectangular recesses 200a, 200b are formed at the centers of the insulating plates 194a, 194b, and terminal plates 192a, 192b are provided in the recesses 200a, 200b. The insulating plates 194a, 194b have holes 202a, 202b. Terminals 196a, 196b of the terminal plates 192a, 192b, and the insulating cylindrical bodies 198 around the terminals 196a, 196b are inserted into the holes 202a, 202b.

As shown in FIG. 15, the movable presser plate 206 of the guide mechanism 205 includes a guide cylinder 208, and the insulating cylindrical body 198 is inserted into the guide cylinder 208. The guide cylinder 208 is slidably fitted to the hole 210 of the end plate 144b. As shown in FIG. 14, the end plate 144a has a hole 212 for inserting the insulating cylindrical body 198.

In the fifth embodiment, the terminal 196b functions to move the movable presser plate 206 in the stacking direction, while keeping the movable presser plate 206 in parallel with the end plate 144b. Thus, the terminal 196b and the pipes 154a, 154b, 156a, 156b cooperatively make it possible to achieve smooth expansion and contraction movement of the movable presser plate 206, and reliably apply the desired tightening load the to the stack body 14.

While the invention has been particularly shown and described with reference to preferred embodiments, it will be understood that variations and modifications can be effected thereto by those skilled in the art without departing from the spirit and scope of the invention as defined by the appended claims.

What is claimed is:

1. A fuel cell stack comprising a stack body, end plates sandwiching said stack body, and a movable presser plate interposed between one of said end plates and said stack body, said stack body being formed by stacking electrolyte electrode assemblies and separators in a stacking direction, said electrolyte electrode assemblies each including a pair of electrodes and an electrolyte interposed between said electrodes, said fuel cell stack further comprising:
an elastic member provided between said movable presser plate and said one end plate for applying a load in the stacking direction to said stack body;
a plurality of guide bars extending in the stacking direction; and
a plurality of bearing members, said guide bars being slidably inserted into said bearing members in the stacking direction.

2. A fuel cell stack according to claim 1, wherein said elastic member and said guide bars are arranged in parallel in the stacking direction.

3. A fuel cell stack according to claim 1, wherein said elastic member comprises a belleville spring.

4. A fuel cell stack according to claim 3, wherein a support shaft for supporting said belleville spring is fixed to said movable presser plate.

5. A fuel cell stack according to claim 1, wherein said guide bars are provided on said movable presser plate or said one end plate; and
said bearing members are provided on said one end plate or said movable presser plate.

6. A fuel cell stack according to claim 1, wherein said stack body has a rectangular shape in a plan view.

7. A fuel cell stack comprising a stack body, end plates sandwiching said stack body, and a movable presser plate interposed between one of said end plates and said stack body, said stack body being formed by stacking electrolyte electrode assemblies and separators in a stacking direction, said electrolyte electrode assemblies each including a pair of electrodes and an electrolyte interposed between said electrodes, said fuel cell stack further comprising:
an elastic member provided between said movable presser plate and said one end plate for applying a load in the stacking direction to said stack body; and
a guide mechanism for moving said movable presser plate in the stacking direction, while keeping said movable presser plate in parallel with said one end plate,
wherein said guide mechanism at least includes two or more pipes extending in the stacking direction, and connected to a reactant gas flow field or a coolant flow field provided in said stack body.

8. A fuel cell stack according to claim 7, wherein said pipes are provided in said movable presser plate, said one end plate has holes, and said pipes are slidably fitted into said holes.

9. A fuel cell stack according to claim 7, wherein a current collection terminal extends through said one end plate in the stacking direction from a current collection plate, and said current collecting terminal is part of said guide mechanism.

10. A fuel cell stack according to claim 9, wherein said movable presser plate has a guide cylinder, and an insulating cylindrical body covering said current collecting terminal is inserted into said guide cylinder; and
said one end plate has a hole, and said guide cylinder is slidably fitted into said hole.

11. A fuel cell stack according to claim 7, wherein said end plates are mounted on a vehicle, and said pipes are connected to deformable pipe members fixed to said vehicle.


SEQUENCE LISTING (94 sequences)

SEQ ID NO: 1 - DNA, 1604 bp, Homo sapiens
acgcgggggtgccgcgcggccccagttctgcgcagcttcccgaggctccgcaccagccgcgcttctgtccgcctgcagggcattccagaaagatgaggatatttgctgtctttatattcatgacctactggcatttgctgaacgcatttactgtcacggttcccaaggacctatatgtggtagagtatggtagcaatatgacaattgaatgcaaattcccagtagaaaaacaattagacctggctgcactaattgtctattgggaaatggaggataagaacattattcaatttgtgcatggagaggaagacctgaaggttcagcatagtagctacagacagagggcccggctgttgaaggaccagctctccctgggaaatgctgcacttcagatcacagatgtgaaattgcaggatgcaggggtgtaccgctgcatgatcagctatggtggtgccgactacaagcgaattactgtgaaagtcaatgccccatacaacaaaatcaaccaaagaattttggttgtggatccagtcacctctgaacatgaactgacatgtcaggctgagggctaccccaaggccgaagtcatctggacaagcagtgaccatcaagtcctgagtggtaagaccaccaccaccaattccaagagagaggagaagcttttcaatgtgaccagcacactgagaatcaacacaacaactaatgagattttctactgcacttttaggagattagatcctgaggaaaaccatacagctgaattggtcatcccagaactacctctggcacatcctccaaatgaaaggactcacttggtaattctgggagccatcttattatgccttggtgtagcactgacattcatcttccgtttaagaaaagggagaatgatggatgtgaaaaaatgtggcatccaagatacaaactcaaagaagcaaagtgatacacatttggaggagacgtaatccagcattggaacttctgatcttcaagcagggattctcaacctgtggtttaggggttcatcggggctgagcgtgacaagaggaaggaatgggcccgtgggatgcaggcaatgtgggacttaaaaggcccaagcactgaaaatggaacctgcgaaagcagaggaggagaatgaagaaagatggagtcaaacagggagcctggagggagaccttgatactttcaaatgcctgaggggctcatcgacgcctgtgacagggagaaaggatacttctgaacaaggagcctccaagcaaatcatccattgctcatcctaggaagacgggttgagaatccctaatttgagggtcagttcctgcagaagtgccctttgcctccactcaatgcctcaatttcttttctgcatgactgagagtctcagtgttggaacgggacagtatttatgtatgagtttttcctatttattttgagtctgtgaggtcttcttgtcatgtgagtgtggttgtgaatgatttcttttgaagatatattgtagtagatgttacaattttgtcgccaaactaaacttgctgcttaatgatttgctcacatctagtaaaacatggagtattcaaaaaaaaaaaaaaaaaaaaaaaaaaaaa

SEQ ID NO: 2 - protein, 290 aa, Homo sapiens
MRIFAVFIFMTYWHLLNAFTVTVPKDLYVVEYGSNMTIECKFPVEKQLDLAALIVYWEMEDKNIIQFVHGEEDLKVQHSSYRQRARLLKDQLSLGNAALQITDVKLQDAGVYRCMISYGGADYKRITVKVNAPYNKINQRILVVDPVTSEHELTCQAEGYPKAEVIWTSSDHQVLSGKTTTTNSKREEKLFNVTSTLRINTTTNEIFYCTFRRLDPEENHTAELVIPELPLAHPPNERTHLVILGAILLCLGVALTFIFRLRKGRMMDVKKCGIQDTNSKKQSDTHLEET

SEQ ID NO: 3 - DNA, 3600 bp, Homo sapiens
acgcgggggtgccgcgcggccccagttctgcgcagcttcccgaggctccgcaccagccgcgcttctgtccgcctgcagggcattccagaaagatgaggatatttgctgtctttatattcatgacctactggcatttgctgaacgcatttactgtcacggttcccaaggacctatatgtggtagagtatggtagcaatatgacaattgaatgcaaattcccagtagaaaaacaattagacctggctgcactaattgtctattgggaaatggaggataagaacattattcaatttgtgcatggagaggaagacctgaaggttcagcatagtagctacagacagagggcccggctgttgaaggaccagctctccctgggaaatgctgcacttcagatcacagatgtgaaattgcaggatgcaggggtgtaccgctgcatgatcagctatggtggtgccgactacaagcgaattactgtgaaagtcaatgccccatacaacaaaatcaaccaaagaattttggttgtggatccagtcacctctgaacatgaactgacatgtcaggctgagggctaccccaaggccgaagtcatctggacaagcagtgaccatcaagtcctgagtggtaagaccaccaccaccaattccaagagagaggagaagcttttcaatgtgaccagcacactgagaatcaacacaacaactaatgagattttctactgcacttttaggagattagatcctgaggaaaaccatacagctgaattggtcatcccagaactacctctggcacatcctccaaatgaaaggactcacttggtaattctgggagccatcttattatgccttggtgtagcactgacattcatcttccgtttaagaaaagggagaatgatggatgtgaaaaaatgtggcatccaagatacaaactcaaagaagcaaagtgatacacatttggaggagacgtaatccagcattggaacttctgatcttcaagcagggattctcaacctgtggtttaggggttcatcggggctgagcgtgacaagaggaaggaatgggcccgtgggatgcaggcaatgtgggacttaaaaggcccaagcactgaaaatggaacctgcgaaagcagaggaggagaatgaagaaagatggagtcaaacagggagcctggagggagaccttgatactttcaaatgcctgaggggctcatcgacgcctgtgacagggagaaaggatacttctgaacaaggagcctccaagcaaatcatccattgctcatcctaggaagacgggttgagaatccctaatttgagggtcagttcctgcagaagtgccctttgcctccactcaatgcctcaatttcttttctgcatgactgagagtctcagtgttggaacgggacagtatttatgtatgagtttttcctatttattttgagtctgtgaggtcttcttgtcatgtgagtgtggttgtgaatgatttcttttgaagatatattgtagtagatgttacaattttgtcgccaaactaaacttgctgcttaatgatttgctcacatctagtaaaacatggagtatttgtaaggtgcttggtctcctctataactacaagtatacattggaagcataaagatcaaaccgttggttgcataggatgtcacctttatttaacccattaatactctggttgacctaatcttattctcagacctcaagtgtctgtgcagtatctgttccatttaaatatcagctttacaattatgtggtagcctacacacataatctcatttcatcgctgtaaccaccctgttgtgataaccactattattttacccatcgtacagctgaggaagcaaacagattaagtaacttgcccaaaccagtaaatagcagacctcagactgccacccactgtccttttataatacaatttacagctatattttactttaagcaattcttttattcaaaaaccatttattaagtgcccttgcaatatcaatcgctgtgccaggcattgaatctacagatgtgagcaagacaaagtacctgtcctcaaggagctcatagtataatgaggagattaacaagaaaatgtattattacaatttagtccagtgtcatagcataaggatgatgcgaggggaaaacccgagcagtgttgccaagaggaggaaataggccaatgtggtctgggacggttggatatacttaaacatcttaataatcagagtaattttcatttacaaagagaggtcggtacttaaaataaccctgaaaaataacactggaattccttttctagcattatatttattcctgatttgcctttgccatataatctaatgcttgtttatatagtgtctggtattgtttaacagttctgtcttttctatttaaatgccactaaattttaaattcatacctttccatgattcaaaattcaaaagatcccatgggagatggttggaaaatctccacttcatcctccaagccattcaagtttcctttccagaagcaactgctactgcctttcattcatatgttcttctaaagatagtctacatttggaaatgtatgttaaaagcacgtatttttaaaatttttttcctaaatagtaacacattgtatgtctgctgtgtactttgctatttttatttattttagtgtttcttatatagcagatggaatgaatttgaagttcccagggctgaggatccatgccttctttgtttctaagttatctttcccatagcttttcattatctttcatatgatccagtatatgttaaatatgtcctacatatacatttagacaaccaccatttgttaagtatttgctctaggacagagtttggatttgtttatgtttgctcaaaaggagacccatgggctctccagggtgcactgagtcaatctagtcctaaaaagcaatcttattattaactctgtatgacagaatcatgtctggaacttttgttttctgctttctgtcaagtataaacttcactttgatgctgtacttgcaaaatcacattttctttctggaaattccggcagtgtaccttgactgctagctaccctgtgccagaaaagcctcattcgttgtgcttgaacccttgaatgccaccagctgtcatcactacacagccctcctaagaggcttcctggaggtttcgagattcagatgccctgggagatcccagagtttcctttccctcttggccatattctggtgtcaatgacaaggagtaccttggctttgccacatgtcaaggctgaagaaacagtgtctccaacagagctccttgttatctgtttgtacatgtgcatttgtacagtaattggtgtgacagtgttctttgtgtgaattacaggcaagaattgtggctgagcaaggcacatagtctactcagtctattcctaagtcctaactcctccttgtggtgttggatttgtaaggcactttatcccttttgtctcatgtttcatcgtaaatggcataggcagagatgatacctaattctgcatttgattgtcactttttgtacctgcattaatttaataaaatattcttatttattttgttacttggtaaaaaaaaa

SEQ ID NO: 4 - DNA, 1443 bp, Artificial Sequence
  Description of Artificial Sequence Synthetic fusion construct
atgcccatggggtctctgcaaccgctggccaccttgtacctgctggggatgctggtcgcttcctgcctcggaactagtgttcccaaggacctatatgtggtagagtatggtagcaatatgacaattgaatgcaaattcccagtagaaaaacaattagacctggctgcactaattgtctattgggaaatggaggataagaacattattcaatttgtgcatggagaggaagacctgaaggttcagcatagtagctacagacagagggcccggctgttgaaggaccagctctccctgggaaatgctgcacttcagatcacagatgtgaaattgcaggatgcaggggtgtaccgctgcatgatcagctatggtggtgccgactacaagcgaattactgtgaaagtcaatgccccatacaacaaaatcaaccaaagaattttggttgtggatccagtcacctctgaacatgaactgacatgtcaggctgagggctaccccaaggccgaagtcatctggacaagcagtgaccatcaagtcctgagtggtaagaccaccaccaccaattccaagagagaggagaagcttttcaatgtgaccagcacactgagaatcaacacaacaactaatgagattttctactgcacttttaggagattagatcctgaggaaaaccatacagctgaattggtcatcccagaactacctctggcacatcctccaaatgaaaggactcgaggagatcccgaggagcccaaatcttgtgacaaaactcacacatgcccaccgtgcccagcacctgaactcctggggggaccgtcagtcttcctcttccccccaaaacccaaggacaccctcatgatctcccggacccctgaggtcacatgcgtggtggtggacgtgagccacgaagaccctgaggtcaagttcaactggtacgtggacggcgtggaggtgcataatgccaagacaaagccgcgggaggagcagtacaacagcacgtaccgtgtggtcagcgtcctcaccgtcctgcaccaggactggctgaatggcaaggagtacaagtgcaaggtctccaacaaagccctcccagcccccatcgagaaaaccatctccaaagccaaagggcagccccgagaaccacaggtgtacaccctgcccccatcccgggatgagctgaccaagaaccaggtcagcctgacctgcctggtcaaaggcttctatcccagcgacatcgccgtggagtgggagagcaatgggcagccggagaacaactacaagaccacgcctcccgtgctggactccgacggctccttcttcctctacagcaagctcaccgtggacaagagcaggtggcagcaggggaacgtcttctcatgctccgtgatgcatgaggctctgcacaaccactacacgcagaagagcctctccctgtctccgggtaaatga

SEQ ID NO: 5 - protein, 480 aa, Artificial Sequence
  Description of Artificial Sequence Synthetic fusion construct
MPMGSLQPLATLYLLGMLVASCLGTSVPKDLYVVEYGSNMTIECKFPVEKQLDLAALIVYWEMEDKNIIQFVHGEEDLKVQHSSYRQRARLLKDQLSLGNAALQITDVKLQDAGVYRCMISYGGADYKRITVKVNAPYNKINQRILVVDPVTSEHELTCQAEGYPKAEVIWTSSDHQVLSGKTTTTNSKREEKLFNVTSTLRINTTTNEIFYCTFRRLDPEENHTAELVIPELPLAHPPNERTRGDPEEPKSCDKTHTCPPCPAPELLGGPSVFLFPPKPKDTLMISRTPEVTCVVVDVSHEDPEVKFNWYVDGVEVHNAKTKPREEQYNSTYRVVSVLTVLHQDWLNGKEYKCKVSNKALPAPIEKTISKAKGQPREPQVYTLPPSRDELTKNQVSLTCLVKGFYPSDIAVEWESNGQPENNYKTTPPVLDSDGSFFLYSKLTVDKSRWQQGNVFSCSVMHEALHNHYTQKSLSLSPGK

SEQ ID NO: 6 - DNA, 3197 bp, Homo sapiens
attcggctcgagggcgactgagccaggctgggccgcgtccctgagtcccagagtcggcgcggcgcggcaggggcagccttccaccacggggagcccagctgtcagccgcctcacaggaagatgctgcgtcggcggggcagccctggcatgggtgtgcatgtgggtgcagccctgggagcactgtggttctgcctcacaggagccctggaggtccaggtccctgaagacccagtggtggcactggtgggcaccgatgccaccctgtgctgctccttctcccctgagcctggcttcagcctggcacagctcaacctcatctggcagctgacagataccaaacagctggtgcacagctttgctgagggccaggaccagggcagcgcctatgccaaccgcacggccctcttcccggacctgctggcacagggcaacgcatccctgaggctgcagcgcgtgcgtgtggcggacgagggcagcttcacctgcttcgtgagcatccgggatttcggcagcgctgccgtcagcctgcaggtggccgctccctactcgaagcccagcatgaccctggagcccaacaaggacctgcggccaggggacacggtgaccatcacgtgctccagctaccagggctaccctgaggctgaggtgttctggcaggatgggcagggtgtgcccctgactggcaacgtgaccacgtcgcagatggccaacgagcagggcttgtttgatgtgcacagcatcctgcgggtggtgctgggtgcaaatggcacctacagctgcctggtgcgcaaccccgtgctgcagcaggatgcgcacagctctgtcaccatcacaccccagagaagccccacaggagccgtggaggtccaggtccctgaggacccggtggtggccctagtgggcaccgatgccaccctgcgctgctccttctcccccgagcctggcttcagcctggcacagctcaacctcatctggcagctgacagacaccaaacagctggtgcacagtttcaccgaaggccgggaccagggcagcgcctatgccaaccgcacggccctcttcccggacctgctggcacaaggcaatgcatccctgaggctgcagcgcgtgcgtgtggcggacgagggcagcttcacctgcttcgtgagcatccgggatttcggcagcgctgccgtcagcctgcaggtggccgctccctactcgaagcccagcatgaccctggagcccaacaaggacctgcggccaggggacacggtgaccatcacgtgctccagctaccggggctaccctgaggctgaggtgttctggcaggatgggcagggtgtgcccctgactggcaacgtgaccacgtcgcagatggccaacgagcagggcttgtttgatgtgcacagcgtcctgcgggtggtgctgggtgcgaatggcacctacagctgcctggtgcgcaaccccgtgctgcagcaggatgcgcacggctctgtcaccatcacagggcagcctatgacattccccccagaggccctgtgggtgaccgtggggctgtctgtctgtctcattgcactgctggtggccctggctttcgtgtgctggagaaagatcaaacagagctgtgaggaggagaatgcaggagctgaggaccaggatggggagggagaaggctccaagacagccctgcagcctctgaaacactctgacagcaaagaagatgatggacaagaaatagcctgaccatgaggaccagggagctgctacccctccctacagctcctaccctctggctgcaatggggctgcactgtgagccctgcccccaacagatgcatcctgctctgacaggtgggctccttctccaaaggatgcgatacacagaccactgtgcagccttatttctccaatggacatgattcccaagtcatcctgctgccttttttcttatagacacaatgaacagaccacccacaaccttagttctctaagtcatcctgcctgctgccttatttcacagtacatacatttcttagggacacagtacactgaccacatcaccaccctcttcttccagtgctgcgtggaccatctggctgccttttttctccaaaagatgcaatattcagactgactgaccccctgccttatttcaccaaagacacgatgcatagtcaccccggccttgtttctccaatggccgtgatacactagtgatcatgttcagccctgcttccacctgcatagaatcttttcttctcagacagggacagtgcggcctcaacatctcctggagtctagaagctgtttcctttcccctccttcctcctcttgctctagccttaatactggccttttccctccctgccccaagtgaagacagggcactctgcgcccaccacatgcacagctgtgcatggagacctgcaggtgcacgtgctggaacacgtgtggttcccccctggcccagcctcctctgcagtgcccctctcccctgcccatcctccccacggaagcatgtgctggtcacactggttctccaggggtctgtgatggggcccctgggggtcagcttctgtccctctgccttctcacctctttgttcctttcttttcatgtatccattcagttgatgtttattgagcaactacagatgtcagcactgtgttaggtgctgggggccctgcgtgggaagataaagttcctccctcaaggactccccatccagctgggagacagacaactaactacactgcaccctgcggtttgcagggggctcctgcctggctccctgctccacacctcctctgtggctcaaggcttcctggatacctcacccccatcccacccataattcttacccagagcatggggttggggcggaaacctggagagagggacatagcccctcgccacggctagagaatctggtggtgtccaaaatgtctgtccaggtgtgggcaggtgggcaggcaccaaggccctctggacctttcatagcagcagaaaaggcagagcctggggcagggcagggccaggaatgctttggggacaccgaggggactgccccccacccccaccatggtgctattctggggctggggcagtcttttcctggcttgcctctggccagctcctggcctctggtagagtgagacttcagacgttctgatgccttccggatgtcatctctccctgccccaggaatggaagatg

SEQ ID NO: 7 - protein, 534 aa, Homo sapiens
MLRRRGSPGMGVHVGAALGALWFCLTGALEVQVPEDPVVALVGTDATLCCSFSPEPGFSLAQLNLIWQLTDTKQLVHSFAEGQDQGSAYANRTALFPDLLAQGNASLRLQRVRVADEGSFTCFVSIRDFGSAAVSLQVAAPYSKPSMTLEPNKDLRPGDTVTITCSSYQGYPEAEVFWQDGQGVPLTGNVTTSQMANEQGLFDVHSILRVVLGANGTYSCLVRNPVLQQDAHSSVTITPQRSPTGAVEVQVPEDPVVALVGTDATLRCSFSPEPGFSLAQLNLIWQLTDTKQLVHSFTEGRDQGSAYANRTALFPDLLAQGNASLRLQRVRVADEGSFTCFVSIRDFGSAAVSLQVAAPYSKPSMTLEPNKDLRPGDTVTITCSSYRGYPEAEVFWQDGQGVPLTGNVTTSQMANEQGLFDVHSVLRVVLGANGTYSCLVRNPVLQQDAHGSVTITGQPMTFPPEALWVTVGLSVCLIALLVALAFVCWRKIKQSCEEENAGAEDQDGEGEGSKTALQPLKHSDSKEDDGQEIA

SEQ ID NO: 8 - DNA, 2097 bp, Artificial Sequence
  Description of Artificial Sequence Synthetic fusion construct
atgctgcgtcggcggggcagccctggcatgggtgtgcatgtgggtgcagccctgggagcactgtggttctgcctcacaggagccctggaggtccaggtccctgaagacccagtggtggcactggtgggcaccgatgccaccctgtgctgctccttctcccctgagcctggcttcagcctggcacagctcaacctcatctggcagctgacagataccaaacagctggtgcacagctttgctgagggccaggaccagggcagcgcctatgccaaccgcacggccctcttcccggacctgctggcacagggcaacgcatccctgaggctgcagcgcgtgcgtgtggcggacgagggcagcttcacctgcttcgtgagcatccgggatttcggcagcgctgccgtcagcctgcaggtggccgctccctactcgaagcccagcatgaccctggagcccaacaaggacctgcggccaggggacacggtgaccatcacgtgctccagctaccagggctaccctgaggctgaggtgttctggcaggatgggcagggtgtgcccctgactggcaacgtgaccacgtcgcagatggccaacgagcagggcttgtttgatgtgcacagcatcctgcgggtggtgctgggtgcaaatggcacctacagctgcctggtgcgcaaccccgtgctgcagcaggatgcgcacagctctgtcaccatcacaccccagagaagccccacaggagccgtggaggtccaggtccctgaggacccggtggtggccctagtgggcaccgatgccaccctgcgctgctccttctcccccgagcctggcttcagcctggcacagctcaacctcatctggcagctgacagacaccaaacagctggtgcacagtttcaccgaaggccgggaccagggcagcgcctatgccaaccgcacggccctcttcccggacctgctggcacaaggcaatgcatccctgaggctgcagcgcgtgcgtgtggcggacgagggcagcttcacctgcttcgtgagcatccgggatttcggcagcgctgccgtcagcctgcaggtggccgctccctactcgaagcccagcatgaccctggagcccaacaaggacctgcggccaggggacacggtgaccatcacgtgctccagctaccggggctaccctgaggctgaggtgttctggcaggatgggcagggtgtgcccctgactggcaacgtgaccacgtcgcagatggccaacgagcagggcttgtttgatgtgcacagcgtcctgcgggtggtgctgggtgcgaatggcacctacagctgcctggtgcgcaaccccgtgctgcagcaggatgcgcacggctctgtcaccatcacagggcagcctatgacattccccccagaattcgagcccaaatcttgtgacaaaactcacacatgcccaccgtgcccagcacctgaactcctggggggaccgtcagtcttcctcttccccccaaaacccaaggacaccctcatgatctcccggacccctgaggtcacatgcgtggtggtggacgtgagccacgaagaccctgaggtcaagttcaactggtacgtggacggcgtggaggtgcataatgccaagacaaagccgcgggaggagcagtacaacagcacgtaccgtgtggtcagcgtcctcaccgtcctgcaccaggactggctgaatggcaaggagtacaagtgcaaggtctccaacaaagccctcccagcccccatcgagaaaaccatctccaaagccaaagggcagccccgagaaccacaggtgtacaccctgcccccatcccgggatgagctgaccaagaaccaggtcagcctgacctgcctggtcaaaggcttctatcccagcgacatcgccgtggagtgggagagcaatgggcagccggagaacaactacaagaccacgcctcccgtgctggactccgacggctccttcttcctctacagcaagctcaccgtggacaagagcaggtggcagcaggggaacgtcttctcatgctccgtgatgcatgaggctctgcacaaccactacacgcagaagagcctctccctgtctccgggtaaatga

SEQ ID NO: 9 - protein, 698 aa, Artificial Sequence
  Description of Artificial Sequence Synthetic fusion construct
MLRRRGSPGMGVHVGAALGALWFCLTGALEVQVPEDPVVALVGTDATLCCSFSPEPGFSLAQLNLIWQLTDTKQLVHSFAEGQDQGSAYANRTALFPDLLAQGNASLRLQRVRVADEGSFTCFVSIRDFGSAAVSLQVAAPYSKPSMTLEPNKDLRPGDTVTITCSSYQGYPEAEVFWQDGQGVPLTGNVTTSQMANEQGLFDVHSILRVVLGANGTYSCLVRNPVLQQDAHSSVTITPQRSPTGAVEVQVPEDPVVALVGTDATLRCSFSPEPGFSLAQLNLIWQLTDTKQLVHSFTEGRDQGSAYANRTALFPDLLAQGNASLRLQRVRVADEGSFTCFVSIRDFGSAAVSLQVAAPYSKPSMTLEPNKDLRPGDTVTITCSSYRGYPEAEVFWQDGQGVPLTGNVTTSQMANEQGLFDVHSVLRVVLGANGTYSCLVRNPVLQQDAHGSVTITGQPMTFPPEFEPKSCDKTHTCPPCPAPELLGGPSVFLFPPKPKDTLMISRTPEVTCVVVDVSHEDPEVKFNWYVDGVEVHNAKTKPREEQYNSTYRVVSVLTVLHQDWLNGKEYKCKVSNKALPAPIEKTISKAKGQPREPQVYTLPPSRDELTKNQVSLTCLVKGFYPSDIAVEWESNGQPENNYKTTPPVLDSDGSFFLYSKLTVDKSRWQQGNVFSCSVMHEALHNHYTQKSLSLSPGK

SEQ ID NO: 10 - DNA, 951 bp, Homo sapiens
atgctgcgtcggcggggcagccctggcatgggtgtgcatgtgggtgcagccctgggagcactgtggttctgcctcacaggagccctggaggtccaggtccctgaagacccagtggtggcactggtgggcaccgatgccaccctgcgctgctccttctcccccgagcctggcttcagcctggcacagctcaacctcatctggcagctgacagacaccaaacagctggtgcacagtttcaccgaaggccgggaccagggcagcgcctatgccaaccgcacggccctcttcccggacctgctggcacaaggcaatgcatccctgaggctgcagcgcgtgcgtgtggcggacgagggcagcttcacctgcttcgtgagcatccgggatttcggcagcgctgccgtcagcctgcaggtggccgctccctactcgaagcccagcatgaccctggagcccaacaaggacctgcggccaggggacacggtgaccatcacgtgctccagctaccggggctaccctgaggctgaggtgttctggcaggatgggcagggtgtgcccctgactggcaacgtgaccacgtcgcagatggccaacgagcagggcttgtttgatgtgcacagcgtcctgcgggtggtgctgggtgcgaatggcacctacagctgcctggtgcgcaaccccgtgctgcagcaggatgcgcacggctctgtcaccatcacagggcagcctatgacattccccccagaggccctgtgggtgaccgtggggctgtctgtctgtctcattgcactgctggtggccctggctttcgtgtgctggagaaagatcaaacagagctgtgaggaggagaatgcaggagctgaggaccaggatggggagggagaaggctccaagacagccctgcagcctctgaaacactctgacagcaaagaagatgatggacaagaaatagcctga

SEQ ID NO: 11 - protein, 316 aa, Homo sapiens
MLRRRGSPGMGVHVGAALGALWFCLTGALEVQVPEDPVVALVGTDATLRCSFSPEPGFSLAQLNLIWQLTDTKQLVHSFTEGRDQGSAYANRTALFPDLLAQGNASLRLQRVRVADEGSFTCFVSIRDFGSAAVSLQVAAPYSKPSMTLEPNKDLRPGDTVTITCSSYRGYPEAEVFWQDGQGVPLTGNVTTSQMANEQGLFDVHSVLRVVLGANGTYSCLVRNPVLQQDAHGSVTITGQPMTFPPEALWVTVGLSVCLIALLVALAFVCWRKIKQSCEEENAGAEDQDGEGEGSKTALQPLKHSDSKEDDGQEIA

SEQ ID NO: 12 - DNA, 951 bp, Homo sapiens
atgctgcgtcggcggggcagccctggcatgggtgtgcatgtgggtgcagccctgggagcactgtggttctgcctcacaggagccctggaggtccaggtccctgaagacccagtggtggcactggtgggcaccgatgccaccctgtgctgctccttctcccctgagcctggcttcagcctggcacagctcaacctcatctggcagctgacagataccaaacagctggtgcacagctttgctgagggccaggaccagggcagcgcctatgccaaccgcacggccctcttcccggacctgctggcacaaggcaatgcatccctgaggctgcagcgcgtgcgtgtggcggacgagggcagcttcacctgcttcgtgagcatccgggatttcggcagcgctgccgtcagcctgcaggtggccgctccctactcgaagcccagcatgaccctggagcccaacaaggacctgcggccaggggacacggtgaccatcacgtgctccagctaccggggctaccctgaggctgaggtgttctggcaggatgggcagggtgtgcccctgactggcaacgtgaccacgtcgcagatggccaacgagcagggcttgtttgatgtgcacagcgtcctgcgggtggtgctgggtgcgaatggcacctacagctgcctggtgcgcaaccccgtgctgcagcaggatgcgcacggctctgtcaccatcacagggcagcctatgacattccccccagaggccctgtgggtgaccgtggggctgtctgtctgtctcattgcactgctggtggccctggctttcgtgtgctggagaaagatcaaacagagctgtgaggaggagaatgcaggagctgaggaccaggatggggagggagaaagctccaagacagccctgcagcctctgaaacactctgacagcaaagaagatgatggacaagaaatagcctga

SEQ ID NO: 13 - protein, 316 aa, Homo sapiens
MLRRRGSPGMGVHVGAALGALWFCLTGALEVQVPEDPVVALVGTDATLCCSFSPEPGFSLAQLNLIWQLTDTKQLVHSFAEGQDQGSAYANRTALFPDLLAQGNASLRLQRVRVADEGSFTCFVSIRDFGSAAVSLQVAAPYSKPSMTLEPNKDLRPGDTVTITCSSYRGYPEAEVFWQDGQGVPLTGNVTTSQMANEQGLFDVHSVLRVVLGANGTYSCLVRNPVLQQDAHGSVTITGQPMTFPPEALWVTVGLSVCLIALLVALAFVCWRKIKQSCEEENAGAEDQDGEGESSKTALQPLKHSDSKEDDGQEIA

SEQ ID NO: 14 - DNA, 2435 bp, Homo sapiens
gctttcgtcagttcctcagaactagttctggtttgactcactctcatgttacggcaaaccttaagctgaatgaacaacttttcttctcttgaatatatcttaacgccaaattttgagtgcttttttgttacccatcctcatatgtcccagctggaaagaatcctgggttggagctactgcatgttgattgttttgtttttccttttggctgttcattttggtggctactataaggaaatctaacacaaacagcaactgttttttgttgtttacttttgcatctttacttgtggagctgtggcaagtcctcatatcaaatacagaacatgatcttcctcctgctaatgttgagcctggaattgcagcttcaccagatagcagctttattcacagtgacagtccctaaggaactgtacataatagagcatggcagcaatgtgaccctggaatgcaactttgacactggaagtcatgtgaaccttggagcaataacagccagtttgcaaaaggtggaaaatgatacatccccacaccgtgaaagagccactttgctggaggagcagctgcccctagggaaggcctcgttccacatacctcaagtccaagtgagggacgaaggacagtaccaatgcataatcatctatggggtcgcctgggactacaagtacctgactctgaaagtcaaagcttcctacaggaaaataaacactcacatcctaaaggttccagaaacagatgaggtagagctcacctgccaggctacaggttatcctctggcagaagtatcctggccaaacgtcagcgttcctgccaacaccagccactccaggacccctgaaggcctctaccaggtcaccagtgttctgcgcctaaagccaccccctggcagaaacttcagctgtgtgttctggaatactcacgtgagggaacttactttggccagcattgaccttcaaagtcagatggaacccaggacccatccaacttggctgcttcacattttcatcccctcctgcatcattgctttcattttcatagccacagtgatagccctaagaaaacaactctgtcaaaagctgtattcttcaaaagacacaacaaaaagacctgtcaccacaacaaagagggaagtgaacagtgctatctgaacctgtggtcttgggagccagggtgacctgatatgacatctaaagaagcttctggactctgaacaagaattcggtggcctgcagagcttgccatttgcacttttcaaatgcctttggatgacccagcactttaatctgaaacctgcaacaagactagccaacacctggccatgaaacttgccccttcactgatctggactcacctctggagcctatggctttaagcaagcactactgcactttacagaattaccccactggatcctggacccacagaattccttcaggatccttcttgctgccagactgaaagcaaaaggaattatttcccctcaagttttctaagtgatttccaaaagcagaggtgtgtggaaatttccagtaacagaaacagatgggttgccaatagagttattttttatctatagcttcctctgggtactagaagaggctattgagactatgagctcacagacagggcttcgcacaaactcaaatcataattgacatgttttatggattactggaatcttgatagcataatgaagttgttctaattaacagagagcatttaaatatacactaagtgcacaaattgtggagtaaagtcatcaagctctgtttttgaggtctaagtcacaaagcatttgttttaacctgtaatggcaccatgtttaatggtggttttttttttgaactacatctttcctttaaaaattattggtttctttttatttgtttttaccttagaaatcaattatatacagtcaaaaatatttgatatgctcatacgttgtatctgcagcaatttcagataagtagctaaaatggccaaagccccaaactaagcctccttttctggccctcaatatgactttaaatttgacttttcagtgcctcagtttgcacatctgtaatacagcaatgctaagtagtcaaggcctttgataattggcactatggaaatcctgcaagatcccactacatatgtgtggagcagaagggtaactcggctacagtaacagcttaattttgttaaatttgttctttatactggagccatgaagctcagagcattagctgacccttgaactattcaaatgggcacattagctagtataacagacttacataggtgggcctaaagcaagctccttaactgagcaaaatttggggcttatgagaatgaaagggtgtgaaattgactaacagacaaatcatacatctcagtttctcaattctcatgtaaatcagagaatgcctttagaaattaccaaagtgttccat

SEQ ID NO: 15 - protein, 273 aa, Homo sapiens
MIFLLLMLSLELQLHQIAALFTVTVPKELYIIEHGSNVTLECNFDTGSHVNLGAITASLQKVENDTSPHRERATLLEEQLPLGKASFHIPQVQVRDEGQYQCIIIYGVAWDYKYLTLKVKASYRKINTHILKVPETDEVELTCQATGYPLAEVSWPNVSVPANTSHSRTPEGLYQVTSVLRLKPPPGRNFSCVFWNTHVRELTLASIDLQSQMEPRTHPTWLLHIFIPSCIIAFIFIATVIALRKQLCQKLYSSKDTTKRPVTTTKREVNSAI

SEQ ID NO: 16 - DNA, 1356 bp, Artificial Sequence
  Description of Artificial Sequence Synthetic fusion construct
atgatcttcctcctgctaatgttgagcctggaattgcagcttcaccagatagcagctttattcacagtgacagtccctaaggaactgtacataatagagcatggcagcaatgtgaccctggaatgcaactttgacactggaagtcatgtgaaccttggagcaataacagccagtttgcaaaaggtggaaaatgatacatccccacaccgtgaaagagccactttgctggaggagcagctgcccctagggaaggcctcgttccacatacctcaagtccaagtgagggacgaaggacagtaccaatgcataatcatctatggggtcgcctgggactacaagtacctgactctgaaagtcaaagcttcctacaggaaaataaacactcacatcctaaaggttccagaaacagatgaggtagagctcacctgccaggctacaggttatcctctggcagaagtatcctggccaaacgtcagcgttcctgccaacaccagccactccaggacccctgaaggcctctaccaggtcaccagtgttctgcgcctaaagccaccccctggcagaaacttcagctgtgtggtctggaatactcacgtgagggaacttactttggccagcattgaccttcaaagtcagatggaacccaggaccgaattcgagcccaaatcttgtgacaaaactcacacatgcccaccgtgcccagcacctgaactcctggggggaccgtcagtcttcctcttccccccaaaacccaaggacaccctcatgatctcccggacccctgaggtcacatgcgtggtggtggacgtgagccacgaagaccctgaggtcaagttcaactggtacgtggacggcgtggaggtgcataatgccaagacaaagccgcgggaggagcagtacaacagcacgtaccgtgtggtcagcgtcctcaccgtcctgcaccaggactggctgaatggcaaggagtacaagtgcaaggtctccaacaaagccctcccagcccccatcgagaaaaccatctccaaagccaaagggcagccccgagaaccacaggtgtacaccctgcccccatcccgggatgagctgaccaagaaccaggtcagcctgacctgcctggtcaaaggcttctatcccagcgacatcgccgtggagtgggagagcaatgggcagccggagaacaactacaagaccacgcctcccgtgctggactccgacggctccttcttcctctacagcaagctcaccgtggacaagagcaggtggcagcaggggaacgtcttctcatgctccgtgatgcatgaggctctgcacaaccactacacgcagaagagcctctccctgtctccgggtaaatga

SEQ ID NO: 17 - protein, 451 aa, Artificial Sequence
  Description of Artificial Sequence Synthetic fusion construct
MIFLLLMLSLELQLHQIAALFTVTVPKELYIIEHGSNVTLECNFDTGSHVNLGAITASLQKVENDTSPHRERATLLEEQLPLGKASFHIPQVQVRDEGQYQCIIIYGVAWDYKYLTLKVKASYRKINTHILKVPETDEVELTCQATGYPLAEVSWPNVSVPANTSHSRTPEGLYQVTSVLRLKPPPGRNFSCVVWNTHVRELTLASIDLQSQMEPRTEFEPKSCDKTHTCPPCPAPELLGGPSVFLFPPKPKDTLMISRTPEVTCVVVDVSHEDPEVKFNWYVDGVEVHNAKTKPREEQYNSTYRVVSVLTVLHQDWLNGKEYKCKVSNKALPAPIEKTISKAKGQPREPQVYTLPPSRDELTKNQVSLTCLVKGFYPSDIAVEWESNGQPENNYKTTPPVLDSDGSFFLYSKLTVDKSRWQQGNVFSCSVMHEALHNHYTQKSLSLSPGK

SEQ ID NO: 18 - DNA, 666 bp, Homo sapiens
agcttttcaatgtgaccagcacactgagaatcaacacaacaactaatgagattttctactgcacttttaggagattagatcctgaggaaaaccatacagctgaattggtcatcccagaactacctctggcacatcctccaaatgaaaggactcacttggtaattctgggagccatcttattatgccttggtgtagcactgacattcatcttccgtttaagaaaagggagaatgatggatgtgaaaaaatgtggcatccaagatacaaactcaaagaagcaaagtgatacacatttggaggagacgtaatccagcattggaacttctgatcttcaagcagggattctcaacctgtggtttaggggttcatcggggctgagcgtgacaagaggaaggaatgggcccgtgggatgcaggcaatgtgggacttaaaaggcccaagcactgaaaatggaacctggcgaaacagaggaggagaatgaagaaagatggagtcaaacagggagcctggagggagaccttgatactttcaaatgcctgaggggctcatcgacgcctgtgacagggagaaaggatacttctgaacaaggagcctccaagcaaatcatccattgctcatcctaggaagacgggttgagaatccctaatttgagggtcagttcctgca

SEQ ID NO: 19 - DNA, 3197 bp, Homo sapiens; identical to SEQ ID NO: 6

SEQ ID NO: 20 - DNA, 842 bp, Homo sapiens
ccggggtaccatgatcttcctcctgctaatgttgagcctggaattgcagcttcaccagatagcagctttattcacagtgacagtccctaaggaactgtacataatagagcatggcagcaatgtgaccctggaatgcaactttgacactggaagtcatgtgaaccttggagcaataacagccagtttgcaaaaggtggaaaatgatacatccccacaccgtgaaagagccactttgctggaggagcagctgcccctagggaaggcctcgttccacatacctcaagtccaagtgagggacgaaggacagtaccaatgcataatcatctatggggtcgcctgggactacaagtacctgactctgaaagtcaaagcttcctacaggaaaataaacactcacatcctaaaggttccagaaacagatgaggtagagctcacctgccaggctacaggttatcctctggcagaagtatcctggccaaacgtcagcgttcctgccaacaccagccactccaggacccctgaaggcctctaccaggtcaccagtgttctgcgcctaaagccaccccctggcagaaacttcagctgtgtgttctggaatactcacgtgagggaacttactttggccagcattgaccttcaaagtcagatggaacccaggacccatccaacttggctgcttcacattttcatcccctcctgcatcattgctttcattttcatagccacagtgatagccctaagaaaacaactctgtcaaaagctgtattcttcaaaagacacaacaaaaagacctgtcaccacaacaaagagggaagtgaacagtgctatctgatctagagcgc

SEQ ID NO: 21 - DNA, 20 bp, Artificial Sequence
  Description of Artificial Sequence Primer
ggcataataagatggctccc

SEQ ID NO: 22 - DNA, 20 bp, Artificial Sequence
  Description of Artificial Sequence Primer
catgaactgacatgtcaggc

SEQ ID NO: 23 - DNA, 20 bp, Artificial Sequence
  Description of Artificial Sequence Primer
catttacaaagagaggtcgg

SEQ ID NO: 24 - DNA, 22 bp, Artificial Sequence
  Description of Artificial Sequence Primer
agggttattttaagtaccgacc

SEQ ID NO: 25 - DNA, 22 bp, Artificial Sequence
  Description of Artificial Sequence Primer
ggaaatgtatgttaaaagcacg

SEQ ID NO: 26 - DNA, 22 bp, Artificial Sequence
  Description of Artificial Sequence Primer
ggcatggatcctcagccctggg

SEQ ID NO: 27 - DNA, 22 bp, Artificial Sequence
  Description of Artificial Sequence Primer
gagacccatgggctctccaggg

SEQ ID NO: 28 - DNA, 22 bp, Artificial Sequence
  Description of Artificial Sequence Primer
gttcaagcacaacgaatgaggc

SEQ ID NO: 29 - DNA, 22 bp, Artificial Sequence
  Description of Artificial Sequence Primer
tggctttgccacatgtcaaggc

SEQ ID NO: 30 - DNA, 34 bp, Artificial Sequence
  Description of Artificial Sequence Primer
tcaggtactagtgttcccaaggacctatatgtgg

SEQ ID NO: 31 - DNA, 42 bp, Artificial Sequence
  Description of Artificial Sequence Primer
gattcgagatctcctcgagtcctttcatttggaggatgtgcc

SEQ ID NO: 32 - DNA, 33 bp, Artificial Sequence
  Description of Artificial Sequence Primer
tcaggtactagtgttcccaaggaccatatgtgg

SEQ ID NO: 33 - DNA, 39 bp, Artificial Sequence
  Description of Artificial Sequence Primer
gattcgagatctcctcgagtctttcattggggatgtgcc

SEQ ID NO: 34 - DNA, 18 bp, Artificial Sequence
  Description of Artificial Sequence Primer
ggtgcacagctttgctga

SEQ ID NO: 35 - DNA, 18 bp, Artificial Sequence
  Description of Artificial Sequence Primer
gctgtgcaccagctgttt

SEQ ID NO: 36 - DNA, 18 bp, Artificial Sequence
  Description of Artificial Sequence Primer
gctatgaaaggtccagag

SEQ ID NO: 37 - DNA, 18 bp, Artificial Sequence
  Description of Artificial Sequence Primer
gaatctggtggtgtccaa

SEQ ID NO: 38 - DNA, 18 bp, Artificial Sequence
  Description of Artificial Sequence Primer
ctctgtcaccatcacagg

SEQ ID NO: 39 - DNA, 18 bp, Artificial Sequence
  Description of Artificial Sequence Primer
ctctgtcaccatcacacc

SEQ ID NO: 40 - DNA, 18 bp, Artificial Sequence
  Description of Artificial Sequence Primer
gaaatcccggatgctcac

SEQ ID NO: 41 - DNA, 18 bp, Artificial Sequence
  Description of Artificial Sequence Primer
accacacgtgttccagca

SEQ ID NO: 42 - DNA, 18 bp, Artificial Sequence
  Description of Artificial Sequence Primer
tgctggaacacgtgtggt

SEQ ID NO: 43 - DNA, 18 bp, Artificial Sequence
  Description of Artificial Sequence Primer
ggccctcagcaaagctgt

SEQ ID NO: 44 - DNA, 18 bp, Artificial Sequence
  Description of Artificial Sequence Primer
agctgtaggtgccattcg

SEQ ID NO: 45 - DNA, 18 bp, Artificial Sequence
  Description of Artificial Sequence Primer
agggacctggacctccac

SEQ ID NO: 46 - DNA, 18 bp, Artificial Sequence
  Description of Artificial Sequence Primer
tggggggaatgtcatagg

SEQ ID NO: 47 - DNA, 18 bp, Artificial Sequence
  Description of Artificial Sequence Primer
agcaggcaggatgactta

SEQ ID NO: 48 - DNA, 18 bp, Artificial Sequence
  Description of Artificial Sequence Primer
aacagaccacccacaacc

SEQ ID NO: 49 - DNA, 18 bp, Artificial Sequence
  Description of Artificial Sequence Primer
gcaaatggcacctacagc

SEQ ID NO: 50 - DNA, 18 bp, Artificial Sequence
  Description of Artificial Sequence Primer
tctggggtgtgatggtga

SEQ ID NO: 51 - DNA, 18 bp, Artificial Sequence
  Description of Artificial Sequence Primer
atgaaaggtccagagggc

SEQ ID NO: 52 - DNA, 18 bp, Artificial Sequence
  Description of Artificial Sequence Primer
acccataattcttaccca

SEQ ID NO: 53 - DNA, 18 bp, Artificial Sequence
  Description of Artificial Sequence Primer
cacagctctgtttgatct

SEQ ID NO: 54 - DNA, 18 bp, Artificial Sequence
  Description of Artificial Sequence Primer
ctcctaccctctggctgc

SEQ ID NO: 55 - DNA, 14 bp, Artificial Sequence
  Description of Artificial Sequence Primer
atgctgcgtcggcg

SEQ ID NO: 56 - DNA, 24 bp, Artificial Sequence
  Description of Artificial Sequence Primer
tcaggctatttcttgtccatcatc

SEQ ID NO: 57 - DNA, 17 bp, Artificial Sequence
  Description of Artificial Sequence Primer
gttttcccagtcacgac

SEQ ID NO: 58 - DNA, 17 bp, Artificial Sequence
  Description of Artificial Sequence Primer
caggaaacagctatgac

SEQ ID NO: 59 - DNA, 17 bp, Artificial Sequence
  Description of Artificial Sequence Primer
tggtgcacagctttgct

SEQ ID NO: 60 - DNA, 17 bp, Artificial Sequence
  Description of Artificial Sequence Primer
tctggggggaatgtcat

SEQ ID NO: 61 - DNA, 17 bp, Artificial Sequence
  Description of Artificial Sequence Primer
tggtgcacagctttgct

SEQ ID NO: 62 - DNA, 17 bp, Artificial Sequence
  Description of Artificial Sequence Primer
tctggggggaatgtcat

SEQ ID NO: 63 - DNA, 22 bp, Artificial Sequence
  Description of Artificial Sequence Primer
ggggtaccatgctgcgtcggcg

SEQ ID NO: 64 - DNA, 25 bp, Artificial Sequence
  Description of Artificial Sequence Primer
cggaattctggggggaatgtcatag

SEQ ID NO: 65 - DNA, 27 bp, Artificial Sequence
  Description of Artificial Sequence Primer
ggaattcgagcccaaatcttgtgacaa

SEQ ID NO: 66 - DNA, 29 bp, Artificial Sequence
  Description of Artificial Sequence Primer
gcgctctagatcatttacccggagacagg

SEQ ID NO: 67 - DNA, 18 bp, Artificial Sequence
  Description of Artificial Sequence Primer
gaaggcctctaccaggtc

SEQ ID NO: 68 - DNA, 18 bp, Artificial Sequence
  Description of Artificial Sequence Primer
ctttaggcgcagaacact

SEQ ID NO: 69 - DNA, 18 bp, Artificial Sequence
  Description of Artificial Sequence Primer
aagggtcagctaatgctc

SEQ ID NO: 70 - DNA, 18 bp, Artificial Sequence
  Description of Artificial Sequence Primer
tcagtttgcacatctgta

SEQ ID NO: 71 - DNA, 18 bp, Artificial Sequence
  Description of Artificial Sequence Primer
tatgctatcaagattcca

SEQ ID NO: 72 - DNA, 18 bp, Artificial Sequence
  Description of Artificial Sequence Primer
gtaaagtgcagtagtgct

SEQ ID NO: 73 - DNA, 18 bp, Artificial Sequence
  Description of Artificial Sequence Primer
tatgagctcacagacagg

SEQ ID NO: 74 - DNA, 18 bp, Artificial Sequence
  Description of Artificial Sequence Primer
aggttcagatagcactgt

SEQ ID NO: 75 - DNA, 18 bp, Artificial Sequence
  Description of Artificial Sequence Primer
acttatctgaaattgctg

SEQ ID NO: 76 - DNA, 18 bp, Artificial Sequence
  Description of Artificial Sequence Primer
ttgatatgctcatacgtt

SEQ ID NO: 77 - DNA, 18 bp, Artificial Sequence
  Description of Artificial Sequence Primer
gaattctgtgggtccagg

SEQ ID NO: 78 - DNA, 18 bp, Artificial Sequence
  Description of Artificial Sequence Primer
catgtttaatggtggttt

SEQ ID NO: 79 - DNA, 18 bp, Artificial Sequence
  Description of Artificial Sequence Primer
aaagctgtattcttcaaa

SEQ ID NO: 80 - DNA, 22 bp, Artificial Sequence
  Description of Artificial Sequence Primer
gaacactggtgacctggtagag

SEQ ID NO: 81 - DNA, 34 bp, Artificial Sequence
  Description of Artificial Sequence Primer
ccggggtaccatgatcttcctcctgctaatgttg

SEQ ID NO: 82 - DNA, 33 bp, Artificial Sequence
  Description of Artificial Sequence Primer
gcgctctagatcagatagcactgttcacttccc

SEQ ID NO: 83 - DNA, 20 bp, Artificial Sequence
  Description of Artificial Sequence Primer
tacaagcgaattactgtgaa

SEQ ID NO: 84 - DNA, 20 bp, Artificial Sequence
  Description of Artificial Sequence Primer
gatgtgccagaggtagttct

SEQ ID NO: 85 - DNA, 20 bp, Artificial Sequence
  Description of Artificial Sequence Primer
aatagagcatggcagcaatg

SEQ ID NO: 86 - DNA, 20 bp, Artificial Sequence
  Description of Artificial Sequence Primer
ggcgaccccatagatgatta

SEQ ID NO: 87 - DNA, 18 bp, Artificial Sequence
  Description of Artificial Sequence Primer
ccagtaagtgcgggtcat

SEQ ID NO: 88 - DNA, 18 bp, Artificial Sequence
  Description of Artificial Sequence Primer
ttcacctacggaaacctt

SEQ ID NO: 89 - DNA, 34 bp, Artificial Sequence; identical to SEQ ID NO: 81
  Description of Artificial Sequence Primer

SEQ ID NO: 90 - DNA, 26 bp, Artificial Sequence
  Description of Artificial Sequence Primer
cggaattcggtcctgggttccatctg

SEQ ID NO: 91 - DNA, 31 bp, Artificial Sequence
  Description of Artificial Sequence Primer
cgggattcatgatcttcctcctgctaatgtt

SEQ ID NO: 92 - DNA, 29 bp, Artificial Sequence
  Description of Artificial Sequence Primer
gcgctctagatcatttacccggagacagg

SEQ ID NO: 93 - protein, 6 aa, Artificial Sequence
  Description of Artificial Sequence Synthetic Epitope tag
HHHHHH

SEQ ID NO: 94 - protein, 8 aa, Artificial Sequence
  Description of Artificial Sequence Synthetic Epitope tag
DYKDDDDK